(19) United States
(12) Patent Application Publication
(10) Pub. No.: US 2024/0335938 A1
(43) Pub. Date: Oct. 10, 2024

(54) AN EXOSKELETON FOR HANDLING OBJECTS AND METHOD OF USING THE SAME

(71) Applicant: Mawashi science & technologies inc., Saint-Jean-sur-Richelieu (CA)

(72) Inventors: Alain BUJOLD, Dollard-des-Ormeaux (CA); Victoria BUDICO, Montreal (CA); Alessandro TELONIO, Sherbrooke (CA); Jean-Francois MORISSETTE, St-Hugues (CA); Dominic FERRON, Chambly (CA); Remi PAQUET, Brossard (CA); Émile Brunelle CAMIRAND, Greenfield Park (CA); Renaud CYR, Saint-Hubert (CA); Christopher MANN, Saint-Jean-sur-Richelieu (CA); David JIMENEZ GARCIA, Saint-Hubert (CA)

(21) Appl. No.: 18/294,346

(22) PCT Filed: Feb. 25, 2022
(86) PCT No.: PCT/CA2022/050275

§ 371 Date: Feb. 1, 2024

Related U.S. Application Data
(60) Provisional application No. 63/237,932, filed on Aug. 27, 2021.

(51) Int. Cl. B25J 9/00

(52) U.S. Cl. CPC B25J 9/0006

(57) ABSTRACT

A wearable exoskeleton and methods of use are discussed herein. The exoskeleton comprises two shoulder bridges connecting a front harness and a back structural plate over shoulders of a user's body, and a back elastomeric element, connected to a tension cable system with shoulder clutches in which the tension cable can be reeled in or out, positioned to follow the back functional line of a user's body with a pre-tension cable system which all together form an artificial myofascial tension line in the exoskeleton. Other elastomeric elements may follow other user's body's myofascial lines to form the other artificial myofascial tension lines and to assist the user in handling objects.

### CROSS-REFERENCE TO RELATED APPLICATIONS

The present application claims priority under to U.S. Provisional Patent Application No. 63/237,932, filed Aug. 27, 2021, which is incorporated herein by reference in its entirety.

### TECHNICAL FIELD

The present invention generally relates to exoskeleton systems, and more particularly to passive exoskeleton systems for lifting, carrying and handling objects.

### BACKGROUND

There has been huge advancement recently in the knowledge of biological mechanisms of the human body, a.k.a. biomechanics, and, in particular, in the understanding of the role of the fascia tissue in the human body, and their interactions with the skeleton framework and the muscle system, how dynamic equilibriums are generated, the whole in mutual synergy of every part of the human body.

In the human body, there is a band or sheet of connective tissue, known as fascia, consisting primarily of collagen, located beneath the skin, and which attaches, stabilizes, encloses, and separates muscles and other internal organs. Fascia is classified by layer, as superficial fascia, deep fascia, and visceral or parietal fascia, or by its function and anatomical location.

Like ligaments, aponeuroses, and tendons, fascia is made up of fibrous connective tissue containing closely packed bundles of collagen fibers oriented in a wavy pattern parallel to the direction of pull. Fascia is consequently flexible and able to resist great unidirectional tension forces until the wavy pattern of fibers has been straightened out by the pulling force. These collagen fibers are produced by fibroblasts located within the fascia.

In the human body, there is a connection, known as the back functional line (BFL), which consists of the connection between the following structures: latissimus dorsi, lumbar fascia, glute max and vastus lateralis, or outermost quadriceps muscle (Wilke, J., Krause, F., Vogt, L., & Banzer, W. (2016). What Is Evidence-Based About Myofascial Chains: A Systematic Review. Archives of Physical Medicine and Rehabilitation, 97 (3), 454-461, doi: 10.1016/j.apmr.2015.07.023). Studies have shown that force can be transmitted along this chain between the lateral and the contralateral lumbar fascia and glute max (Krause, F., Wilke, J., Vogt, L., & Banzer, W. (2016). Intermuscular force transmission along myofascial chains: a systematic review. Journal of Anatomy, 228 (6), 910-918. doi: 10.1111/joa.12464).

At present, manual workers having to lift, carry, and handle heavy objects on a frequent basis, perform their tasks without any help, relying solely on the muscular system and skeletal framework of their bodies. This leads to rapid muscular and nervous exertion, as well as long-term damages to their skeletal joints. By performing their tasks in such manner, manual workers are limited in productivity, because of a limited period during which they are able to perform the tasks.

Therefore, there is a need for an improved apparatus for lifting, carrying and handling objects that would be more efficient, and that would efficiently allow for an increased performance of workers having to lift, carry, and handle heavy objects on a frequent basis, and hence would mitigate some of the shortcomings of the prior art.

### SUMMARY

It is the object of the present disclosure to apply the above cited knowledge for the purpose of helping manual workers having to lift, carry, and handle heavy objects on a frequent basis, to accomplish their tasks in a more efficient manner, without having to rely on external power supplies such as electrical equipment, etc.

The exoskeleton as described herein intends to reproduce bio-inspired myofascial tension lines, preferably the back functional line of the human body, to actuate in synergy the knee (in some embodiments, assisted by a separate actuation system), lower back, shoulder and elbow joints (in some embodiments, assisted by a separate actuation system) of the user, or only a few of those joints, if so desired.

Immediate applications of the present invention may be found in the construction industry, logistics, but also in the health sector, where workers have to use the strength of their lower limbs and upper body regularly. The need for the present invention in such specialized fields may have also become more important, given the aging of the qualified personnel.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

According to one aspect of the disclosed technology, there is provided a wearable exoskeleton for a body of a user, the body of the user having a front side and a back side, a median plane and a back functional line located on the back side, the exoskeleton comprising: a front harness configured for positioning on the front side of the body and a back structural plate configured for positioning on the back side of the body, two shoulder bridges connecting the front harness and the back structural plate over shoulders of the body; a back elastomeric element having two back elastomeric element branches, each back elastomeric element branch being coupled to at least one thigh harness positioned on a thigh of the user, the back elastomeric element being positioned to follow the path of the back functional line of the human body, to form an artificial myofascial tension line in the exoskeleton and to accumulate potential energy when the back elastomeric element is elastically elongated, the back elastomeric element being configured to elongate when the exoskeleton is bent in the median plane along the myofascial tension line and to retract using the accumulated potential energy when exoskeleton is unbent in the median plane along the myofascial tension line thereby providing an additional force to the user to unbend; another way to accumulate potential energy in the artificial myofascial tension line is when a shoulder clutch system (positioned on the arm) is engaged (locked state) and a rigid cable system, connected both to the shoulder clutch system and to the elastomeric element, pulls on the elastomeric element and stores additional potential energy; tension cables coupled to at least one arm harness possibly through a clutch system, to the back elastomeric element (via a connector) and to the back structural plate; and a pre-tension cable system coupled to the back structural plate and the back elastomeric element for setting an initial tension of the back elastomeric element.

According to another aspect of the present technology, there is provided herein a wearable exoskeleton for a body of a user, the body of the user having a front side and a back side, a median plane and a back functional line located on the back side, the exoskeleton comprising: a front harness configured for positioning on the front side of the body and a back structural plate configured for positioning on the back side of the body, two shoulder bridges connecting the front harness and the back structural plate over shoulders of the body; a back elastomeric element having two back elastomeric element branches, each back elastomeric element branch being coupled to a thigh harness positioned on a thigh of the user, the back elastomeric element being positioned to follow the back functional line of the body, to form an artificial myofascial tension line in the exoskeleton and to accumulate a potential energy when the back elastomeric element is elastically elongated, the back elastomeric element being configured to elongate, either when the body of the user bends forward and/or flexes user's knees or when the user pulls on the elastomeric element with user's arms, such that the exoskeleton transmits the accumulated potential energy to the user either when the user returns to a standing position thereby providing an additional force to the user to unbend or when lifting an object with the arm thereby providing the additional force to support and lift the object; and a pre-tension cable system coupled to the back structural plate and the back elastomeric element for setting an initial tension of the back elastomeric element. In at least one embodiment, the back elastomeric element is configured to elongate either when the body of the user bends forward and/or flexes user's knees or when the shoulder clutch system is in a lock mode and the user pulls on the elastomeric element with user's arms. In at least one embodiment, when the shoulder clutch system is in a lock mode, the user can pull on the elastomeric element. In at least one embodiment, the clutch system needs to be activated to be in a lock mode and the lock mode is not triggered just by pulling on the elastomeric element.

In at least one embodiment, the pre-tension back cable system is coupled to: the front harness of the user, at least one cable guide attached to the back structural plate, and a connector attached to the back elastomeric element, the pre-tension back cable system being configured to adjust an initial tension in the back elastomeric element.

In at least one embodiment, the back elastomeric element comprises two back elastomeric branches and forming a portion of (in other words, a part of) the artificial myofascial tension line (with the tension cable system), each back elastomeric branch coupled to one thigh harness to be positioned on one thigh of the user, each one back elastomeric branch configured to be positioned over gluteal muscles and at least in part over lumbar region following the back functional line of the user. In at least one embodiment, the exoskeleton further comprises tension cables coupled to an arm harness, optionally via a shoulder clutch system, and to the back structural plate. The exoskeleton may comprise a shoulder clutch system, connected to the arm harness and an arm structure, an arm tension cable connected to the shoulder clutch system and configured to be reeled inside the clutch structure, such that when the clutch system is activated, the clutch system is configured to block the arm tension cable winding, and, in turn, to fix the arm tension cable length, and when engaged, the clutch system allows the user, by moving downward the user arms to pull on the back elastomeric element to get support at the shoulder level and also to use the potential energy stored in the elastomeric element to lift and handle an object. When deactivated, the arm tension cable may be reeled inside the clutch and the arm is not restricted in its movement.

In at least one embodiment, the shoulder bridges are structural elements, each shoulder bridge elevated above the user's shoulder and configured to reroute tension cables, in order to avoid or minimize contacts of the cables with the user's shoulder, towards an arm harness. An arm tension cable may be coupled to an arm harness or a shoulder clutch. The tension cables may be rerouted towards the arm harness via a shoulder clutch system.

In at least one embodiment, the coupling of the arm tension cable with the arm harness is done via a shoulder clutch system where the arm tension cable can be reeled into in order to change the arm tension cable length. When engaged, the clutch can be locked in position by the user with a specific movement such as a downward arm movement and the arm cable can no longer be reeled inside or unreeled outside the clutch (fixed arm cable length). When disengaged, the arm cable is reeled inside the clutch or unreeled outside of the clutch following the arm's movements.

In at least one embodiment, each one of the shoulder bridges has an elevated upper shoulder bridge surface and a shoulder-engaging surface, a longest distance between the elevated upper shoulder bridge surface and the shoulder-engaging surface being preferably, but not limited to, about 5 centimeters.

In at least one embodiment, the exoskeleton further comprises an inter-arm elastomeric element, the inter-arm elastomeric element running from one arm and forearm harnesses to another arm and forearm harnesses through the back of the user and forming an arm tension line, such that when moving the elbow of the user, a second potential energy is stored in the arm tension line for using this second potential energy for moving objects with the user's arm. The arm tension line may assist the user's elbow joints.

In at least one embodiment, each arm harness is coupled to the shoulder clutch system and is configured to receive and to adhere to a portion of the user's arm.

In at least one embodiment, the exoskeleton further comprises an elbow elastomeric element coupled to the arm and forearm harnesses, the elbow elastomeric element having a plurality of pivot points defining routing of an elbow tension line located on the arm and forearm, such that when moving the elbow of the user, a second potential energy is stored in the elbow tension line for using this second potential energy for moving objects with the user's arm.

In at least one embodiment, the exoskeleton further comprises a forearm harness coupled to the arm harness, the forearm harness being configured to receive and to adhere to a portion of the user's forearm, and optionally connected to the elbow elastomeric element and to the arm harness. The forearm harness may be present even if there is no elbow tension line (or an arm tension line with the inter-arm elastomeric element).

The arm tension cable may be slidably coupled to the back structural plate via a plurality of tension cables, each tension cable of the plurality of tension cables being slidably coupled to the back structural plate and slidably coupled to one of the shoulder bridges. Each one of the tension cables may be coupled to the back structural plate via cable guides, the cable guides being immovably attached to the back structural plate.

The exoskeleton may further comprise a calf harness for receiving and adhering to a portion of a user's calf, the calf harness being coupled to the thigh harness.

In at least one embodiment, the exoskeleton further comprises a knee actuation system coupled to the thigh harness and the calf harness, the knee actuation system comprising a spring mechanism (or another mechanism capable to store and restore mechanical energy) coupled to a knee cable configured to compress or expand the spring mechanism to store potential energy. The back elastomeric element may extend along the back functional line of the user to the calf harness and may be coupled to the calf harness to assist the user's knee joints. The exoskeleton as described herein may be used to displace an object.

According to another aspect of the disclosed technology there is provided herein a method for handing an object when wearing the exoskeleton, the method comprising: activating the shoulder clutch system (turned ON); reducing a length of the arm tension cable (cable reeled into the shoulder clutch) by displacing the arm harness away from a first arm harness position to reach a second arm harness position; slightly moving the arm back towards the first arm harness position (in other words, in the opposite direction to the previous arm movement) to lock the shoulder clutch system and fix the length of the arm tension cable in order to use the tension and the potential energy stored in the artificial myofascial tension line of the exoskeleton to assist the user's shoulder; bending forward the back and flexing the knees of user to a third position in order to store additional potential energy in the back elastomeric element; picking up an object with the arms; and unbending the exoskeleton along the artificial myofascial tension line to a fourth position (for example, close to a standing position, or towards the standing position of the user) to use the potential energy accumulated in the back elastomeric element to lift and carry the object handled. The method may further comprise, prior to activating the shoulder clutch, adding pre-tension in the back elastomeric element by pulling on the pre-tension system. The method may comprise, prior to activating the shoulder clutch system and reducing the length of the arm tension cable and storing the potential energy in the artificial myofascial tension line, setting a pre-tension in the back elastomeric element using the pre-tension cable system by pulling on the pre-tension cable system.

In at least one embodiment, the method further comprises, prior to prior to activating the shoulder clutch system and reducing the length of the arm tension cable and storing the potential energy in the artificial myofascial tension line, setting a pre-tension in the back elastomeric element using the pre-tension cable system by pulling on the pre-tension cable system.

According to another aspect of the disclosed technology there is provided a wearable exoskeleton comprising: two shoulder bridges connecting a front harness and a back structural plate over shoulders of a user's body; a back elastomeric element positioned to follow the back functional line of the user's body; tension cables directly coupled to at least one arm harness or coupled via a shoulder clutch system positioned on the arm and to the back structural plate, and to the back elastomeric element; and a pre-tension cable system. According to another aspect of the disclosed technology there is provided a wearable exoskeleton comprising two shoulder bridges connecting a front harness and a back structural plate over shoulders of a user's body; a back elastomeric element positioned to follow a back functional line of the user's body; tension cables coupled to at least one arm harness, to the back structural plate, and to the back elastomeric element; a shoulder clutch system connected to the at least one arm harness and an arm structure where an arm tension cable can be reeled; and a pre-tension cable system. According to another aspect of the disclosed technology there is provided a wearable exoskeleton comprising two shoulder bridges connecting a front harness and a back structural plate over shoulders of a user's body; a back elastomeric element positioned to follow a back functional line of the user's body; tension cables coupled to at least one arm harness, to the back structural plate, and to the back elastomeric element; a shoulder clutch system connected to the at least one arm harness and an arm structure where an arm tension cable can be reeled. In at least one embodiment, the tension cable system and the back elastomeric element connected to the tension cable system form an artificial myofascial tension line in the exoskeleton. In at least one embodiment, the pre-tension cable system is also part of the artificial myofascial tension line.

The exoskeleton may further comprise an inter-arm elastomeric element, the inter-arm elastomeric element running from one arm and forearm harnesses to another arm, and to forearm harnesses, through the back of the user and forming an arm tension line for assisting the user's elbows. The exoskeleton may further comprise an elbow elastomeric element coupled to the arm and forearm harnesses, the elbow elastomeric element having a plurality of pivot points defining routing of an elbow tension line located on the arm and forearm.

In at least one embodiment, there is provided a shoulder clutch system, connected to the arm harness and arm structure. The arm tension cable is connected to the clutch system and can be reeled inside the clutch structure. The clutch system, when activated, may block the arm tension cable winding, and, in turn, fixes the arm tension cable length. Also, when engaged, the clutch system allows the user, by moving downward his/her arms to pull on the back elastomeric element to get support at the shoulder level and also to use the potential energy stored in the elastomeric element to lift and handle an object. When deactivated, the arm tension cable may be reeled inside the clutch and the arm is not restricted in its movement.

### BRIEF DESCRIPTION OF THE DRAWINGS

The above and other aspects, features and advantages of the invention will become more readily apparent from the following description, reference being made to the accompanying drawings in which:

FIG. 1A is a back view of a user wearing an exoskeleton, in accordance with the principles of the present invention, highlighting a back elastomeric element.

FIG. 1B is a right side back view of the user wearing the exoskeleton of FIG. 1A, in accordance with the principles of the present invention, highlighting the back elastomeric element.

FIG. 2A is a back view of the user wearing the exoskeleton of FIG. 1A, in accordance with the principles of the present invention, highlighting an integrated cable system for pre-tension.

FIG. 2B is a left side front view of the user wearing the exoskeleton of FIG. 1A, in accordance with the principles of the present invention, highlighting the integrated cable system for pre-tension.

FIG. 2C is a front view of the user wearing the exoskeleton of FIG. 1A, in accordance with the principles of the present invention, highlighting the integrated cable system for pre-tension.

FIG. 3 is a back view of the user wearing the exoskeleton of FIG. 1A, in accordance with the principles of the present invention, schematizing in dotted lines a routing of myofascial tension lines from thighs to forearms.

FIG. 4 is a partial top back view of the user wearing the exoskeleton of FIG. 1A, in accordance with the principles of the present invention, highlighting a connector.

FIG. 5A is a left side front view of the user wearing the exoskeleton of FIG. 1A, in accordance with the principles of the present invention, highlighting an embodiment of the elbow tension line where the elastomeric element of this tension line is decoupled for each arm and has a complex routing on the arm harness.

FIG. 5B is a right side back view of the user wearing the exoskeleton of FIG. 1A, in accordance with the principles of the present invention, highlighting an embodiment of the elbow tension line where the elastomeric element of this tension line is decoupled for each arm and has a complex routing on the arm harness.

FIG. 6A is a left side front view of the user wearing the exoskeleton of FIG. 1A, in accordance with the principles of the present invention, highlighting an embodiment of the elbow tension line where the left and right arms are connected by an inter-arm elastomeric element.

FIG. 6B is a right side back view of the user wearing the exoskeleton of FIG. 1A, in accordance with the principles of the present invention, highlighting an embodiment of the elbow tension line where the left and right arms are connected by the inter-arm elastomeric element.

FIG. 7A is a back view of the user wearing the exoskeleton of FIG. 1A, in accordance with the principles of the present invention, highlighting an embodiment where the myofascial tension line stops at the shoulder clutch system and does not actuate the elbow joints.

FIG. 7B is a front view of the user wearing the exoskeleton of FIG. 7A, in accordance with the principles of the present invention, highlighting an embodiment schematizing with dots that the myofascial tension line stops at the shoulder clutch system and does not actuate the elbow joints.

FIG. 8 depicts a method of use of the exoskeleton of FIG. 1A, in accordance with at least one embodiment of the present disclosure.

FIG. 9A is a back view of the user wearing the exoskeleton of FIG. 1A, in accordance with the principles of the present invention, highlighting in dotted lines the upper part of the myofascial tension lines from the connector to the shoulder clutch system, and embodied as the tension cable system.

FIG. 9B is a front view of the user wearing the exoskeleton of FIG. 1A, in accordance with the principles of the present invention, highlighting in dotted lines the upper part of the myofascial tension lines from the connector to the shoulder clutch system, and embodied as the tension cable system.

FIG. 9C is a right-side view of the user wearing the exoskeleton of FIG. 1A, in accordance with the principles of the present invention, highlighting in dotted lines the upper part of the myofascial tension lines from the connector to the shoulder clutch system, and embodied as the tension cable system.

FIG. 10 is a partial top back view of the user wearing the exoskeleton of FIG. 1A, in accordance with the principles of the present invention, highlighting the integrated cable system for pre-tension.

FIG. 11A is a back view of the user wearing the exoskeleton of FIG. 1A, in accordance with the principles of the present invention, highlighting the shoulder bridges.

FIG. 11B is a right-side view of the user wearing the exoskeleton of FIG. 1A, in accordance with the principles of the present invention, highlighting the shoulder bridges.

FIG. 11C is a front view of the user wearing the exoskeleton of FIG. 1A, in accordance with the principles of the present invention, highlighting the shoulder bridges.

FIG. 12A is a back view of the user wearing the exoskeleton of FIG. 1A, in accordance with the principles of the present invention, highlighting the shoulder clutch system.

FIG. 12B is a front left side view of the user wearing the exoskeleton of FIG. 1A, in accordance with the principles of the present invention, highlighting the shoulder clutch system.

FIG. 12C is a front view of the user wearing the exoskeleton of FIG. 1A, in accordance with the principles of the present invention, highlighting the shoulder clutch system.

FIG. 13A is a back view of the user wearing the exoskeleton of FIG. 1A, in accordance with the principles of the present invention, highlighting the arm structure, comprising the arm harness and the forearm harness.

FIG. 13B is a right-side view of the user wearing the exoskeleton of FIG. 1A, in accordance with the principles of the present invention, highlighting the arm structure, comprising the arm harness and the forearm harness.

FIG. 13C is a front view of the user wearing the exoskeleton of FIG. 1A, in accordance with the principles of the present invention, highlighting the arm structure, comprising the arm harness and the forearm harness.

FIG. 14A is a back view of the user wearing the exoskeleton of FIG. 1A, in accordance with the principles of the present invention, highlighting the thigh harness and the calf harness.

FIG. 14B is a right-side view of the user wearing the exoskeleton of FIG. 1A, in accordance with the principles of the present invention, highlighting the thigh harness and the calf harness.

FIG. 14C is a front view of the user wearing the exoskeleton of FIG. 1A, in accordance with the principles of the present invention, highlighting the thigh harness and the calf harness.

FIG. 15A is a back view of the user wearing the exoskeleton of FIG. 1A, in accordance with the principles of the present invention, highlighting the knee actuation system.

FIG. 15B is a right-side view of the user wearing the exoskeleton of FIG. 1A, in accordance with the principles of the present invention, highlighting the knee actuation system.

FIG. 15C is a front view of the user wearing the exoskeleton of FIG. 1A, in accordance with the principles of the present invention, highlighting the knee actuation system.

FIG. 16 is a partial back view of the user wearing the exoskeleton of FIG. 1A, in accordance with the principles of the present invention, highlighting the back structural plate.

FIG. 17A is a front view of the user wearing the exoskeleton of FIG. 1A, in accordance with the principles of the present invention, highlighting the front harness.

FIG. 17B is a left side front view of the user wearing the exoskeleton of FIG. 1A, in accordance with the principles of the present invention, highlighting the front harness.

FIG. 18 is a right side back view of the user wearing the exoskeleton of FIG. 1A, in accordance with the principles of the present invention, highlighting the myofascial tension lines at work when the user is handling an object.

FIG. 19 is a partial top back view of the user wearing the exoskeleton of FIG. 1A, in accordance with the principles of the present invention.

FIG. 20 is a partial right-side view of the user wearing the exoskeleton of FIG. 1A, in accordance with the principles of the present invention.

FIG. 21 is a right-side schematic view of a knee actuation system as used with the exoskeleton of FIG. 1A, in accordance with the principles of the present invention.

FIG. 22A to FIG. 22F illustrate a sequence of postures of the user wearing the exoskeleton of FIG. 1A, in accordance with the principles of the present invention, while handling an object, and illustrating the myofascial tension lines at work.

It will be noted that throughout the appended drawings, like features are identified by like reference numerals.

### DETAILED DESCRIPTION

Various aspects of the present disclosure generally address one or more of the problems of lifting, carrying, and handling of objects, including heavy objects.

A novel exoskeleton and a method for handling an object using the exoskeleton are described herein. Although the exoskeleton and the method are described in terms of specific illustrative embodiments, it is to be understood that the embodiments described herein are by way of example only and that the scope of the invention is not intended to be limited thereby.

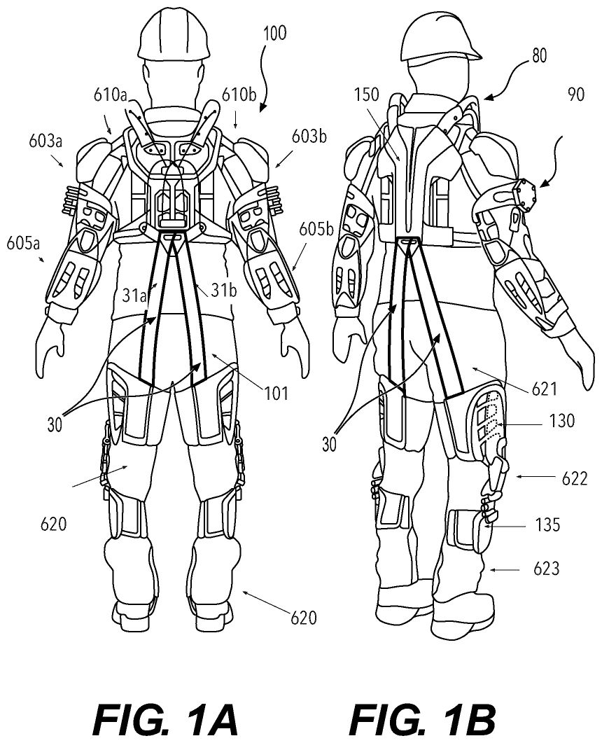

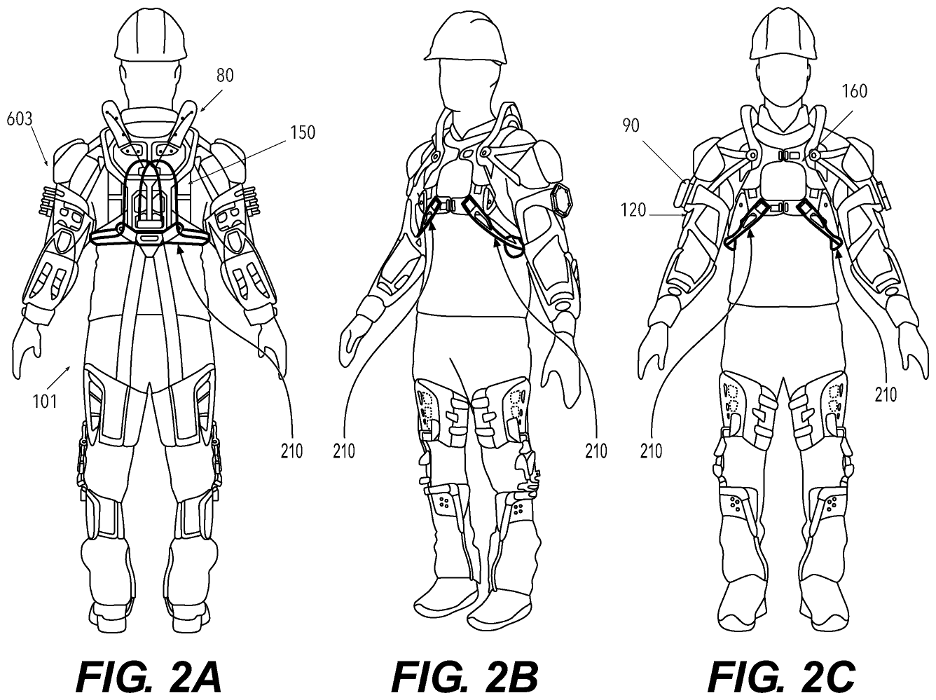

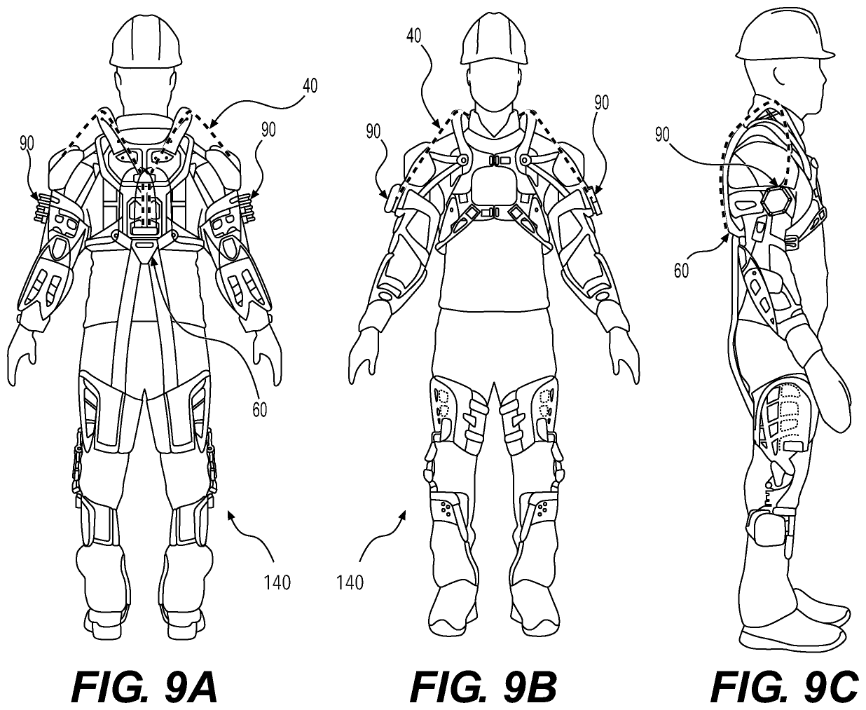

FIGS. 1A to 22F depict an exoskeleton 100 in accordance with various embodiments of the present disclosure. The exoskeleton 100 is designed to be worn over the body of a user 101, secured to the user's body by attachment means, such as straps, buckles and hooks and loops systems. The exoskeleton 100 is provided for a body of the user 101. The user's body has a torso 600, arms 603a, 603b (also referred to herein collectively as arms 603), shoulders 610a, 610b, upper back region 615, forearms 605a, 605b, legs 620 having thighs 621, knees 622 and calves 623. The user's body has a back side (see, for example, FIG. 1A) and a front side (see, for example, FIG. 2C). A back functional line (BFL) of the user's body as described above is located on the user's back side. As noted above, in the user's body, the BFL comprises a connection of the following structures: latissimus dorsi, lumbar fascia, glute max and vastus lateralis, or outermost quadriceps muscle.

In at least one embodiment, the exoskeleton 100 comprises a front harness 160 configured for positioning on the front side of the user's body and a back structural plate 150 configured for positioning on the user's back side.

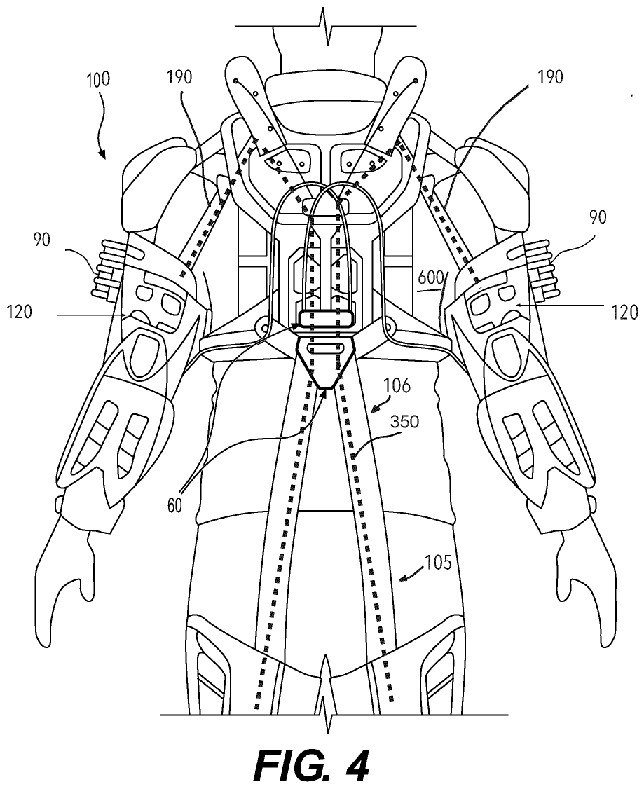

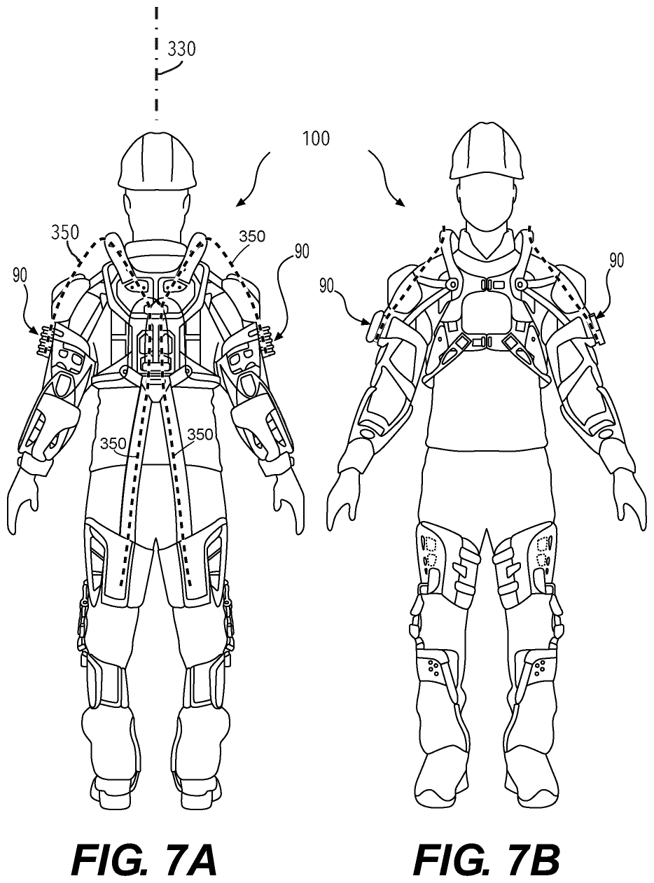

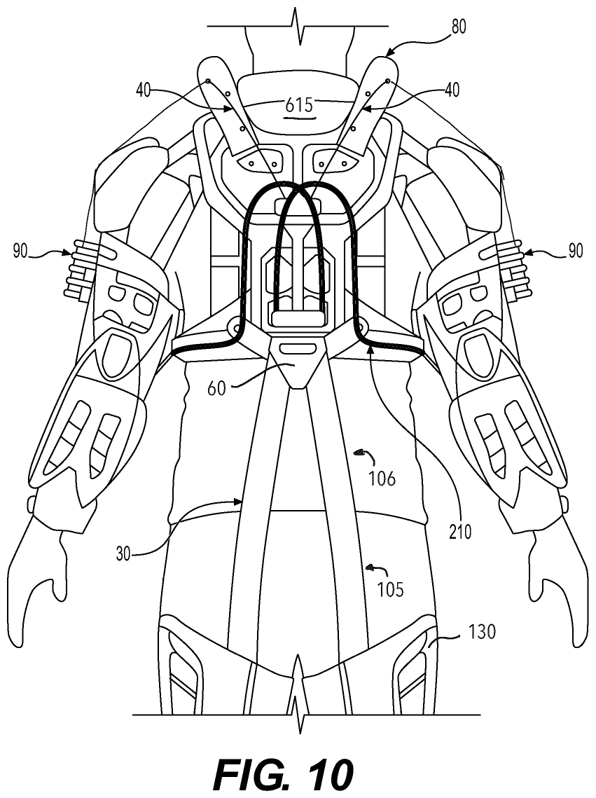

The exoskeleton 100 comprises a myofascial tension line (MTL) 350 comprising a back elastomeric element 30 operatively connected to a tension cable system 40 (see FIG. 10). The myofascial tension line 350 (illustrated, for example, in FIG. 7A) follows the BFL, but in a simplified manner. For instance, the exoskeleton 100 (and the MTL 350) may comprise also a connector 60 (see FIG. 4), to be preferably located on the back of the user, for connecting, in the back of the user 101, the elastomeric elements 30 to the tension cable system 40. The exoskeleton 100 as described herein may be also referred to as a “wearable exoskeleton 100”.

In at least one embodiment, the exoskeleton 100 comprises a back structural plate 150, the elastomeric element 30 (which comprises a first and a second elastomeric element branches 31a, 31b), the connector 60, a pre-tension cable system 210 and shoulder bridges 80 configured to connect the back structural plate 150 with a front harness 160.

Two shoulder bridges 80 connect the front harness 160 and the back structural plate 150 over shoulders 610a, 610b of the body.

The back elastomeric element 30 is splitting at one end downward in two branches and each branch is connected to a thigh harness 130 on each leg, and connected at the other end to the connector 60 (see FIG. 4). When worn by the user, each one of two back elastomeric element branches 31a, 31b (also referred to herein as a first back elastomeric branch 31a and a second back elastomeric branch 31b) of the back elastomeric element 30 passes over the gluteal muscles 105 of the user (illustrated schematically in FIG. 4) and on part, or all, of a lumbar region 106. Each back elastomeric element branch 31a, 31b of the back elastomeric element 30 corresponds to one leg of the user (and therefore user's gluteal muscles 105 related to the corresponding leg). The back elastomeric element 30 (in other terms, each one of the first and second back elastomeric element branches 31a, 31b) of the MTL 350 may be pre-tensioned manually by the user to a certain level (e.g. depending on the user's size and morphology as well as the nature of tasks/activities performed) to optimize the assistance provided by the MTL 350. In at least one embodiment, the back elastomeric element 30 may be pre-tensioned (in other words, an initial tension of the back elastomeric element 30 may be set) by a pre-tension cable system 210 (highlighted in FIG. 10).

In at least one embodiment, the back elastomeric element 30 thus comprises two back elastomeric branches 31a, 31b and forms a portion of a myofascial tension line 350 of the exoskeleton 100 (also referred to herein as an “artificial myofascial tension line 350”). Two sections of the myofascial tension lines 350 that are formed in the exoskeleton 100 are illustrated in FIGS. 7A, 7B.

Each section of the myofascial tension line 350 is formed by one of the back elastomeric branches 31a (or 31b), one or more tension cables 50 located in the back side of the exoskeleton 100 then following these tension cables 50 to a tip of the shoulder bridge 80 (to the elevated upper shoulder bridge surface 81) and then via the tension cables 50 via the arm tension cable 51 towards the shoulder clutch system 90. As illustrated in FIGS. 7A, 7B, the myofascial tension line 350 is approximately symmetrical vis-à-vis (with reference to) a median plane 330 of the user 101.

Referring to FIGS. 1A, 1B, each back elastomeric branch 31a, 31b may be coupled to one thigh harness 130 to be positioned on one thigh 621 of the user 101, and each one back elastomeric branch 31a, 31b may be configured to be positioned over gluteal muscles 105 and at least in part over lumbar region 106 (FIG. 4) following the back functional line of the user 101.

The back elastomeric element 30 is coupled to at least one thigh harness 130 positioned on a thigh 621 of the user 101. The back elastomeric element 30 is positioned to follow the back functional line of the body as illustrated in FIG. 4.

When referred to herein, the back functional line of the body is the line proper to the muscles in the user's body, while the myofascial tension line 350, unless specified otherwise, is the tension line formed by the elements of the exoskeleton 100. Such formed myofascial tension lines 350 may be referred to as “artificial myofascial tension lines 350” because they are artificially formed in the exoskeleton 100. The artificial myofascial tension lines 350 in the exoskeleton 100 follow the location of the user's body's (intrinsic) myofascial lines, including the back functional line of the body.

The back elastomeric element 30 accumulates a potential energy when the back elastomeric element 30 is elastically elongated. The back elastomeric element 30 is configured to elongate when the back functional line of the user's body 100 is bent forward (in other words, when the user bends forward) and/or when the user flexes the user's knees, and to retract using the accumulated potential energy when the back functional line is unbent thus providing additional force to the user 101 to unbend (and/or straighten) the back functional line, when, for example, lifting an object 102. Thus, less force is required to be applied by user 101 to lift the object 102 or otherwise displace the object 102.

In at least one embodiment, the back elastomeric element 30 is configured to elongate, either when the body of the user bents forward and flexes his/her user's knees or when the shoulder clutch 90 is in a lock mode and the user pulls on the elastomeric element with user's arms. The exoskeleton 100 thus transmits the accumulated potential energy to the user 101 either when the user 101 returns to a standing position thereby providing an additional force to the user to unbend, or when lifting an object with the arm thereby providing an additional force to support and lift the object.

When the shoulder clutch 90 is activated and in lock mode, the user arm 603 can be partly or fully supported by the tension in the back elastomeric elements and thus a portion of the weight of an object can be supported at the shoulder level by the elastomeric element 102. Potential energy can also be stored in the back elastomeric element 30 when the user with shoulder clutch 90 in lock mode applies a downward force with his/her arms, thus pulling on the back elastomeric element 30.

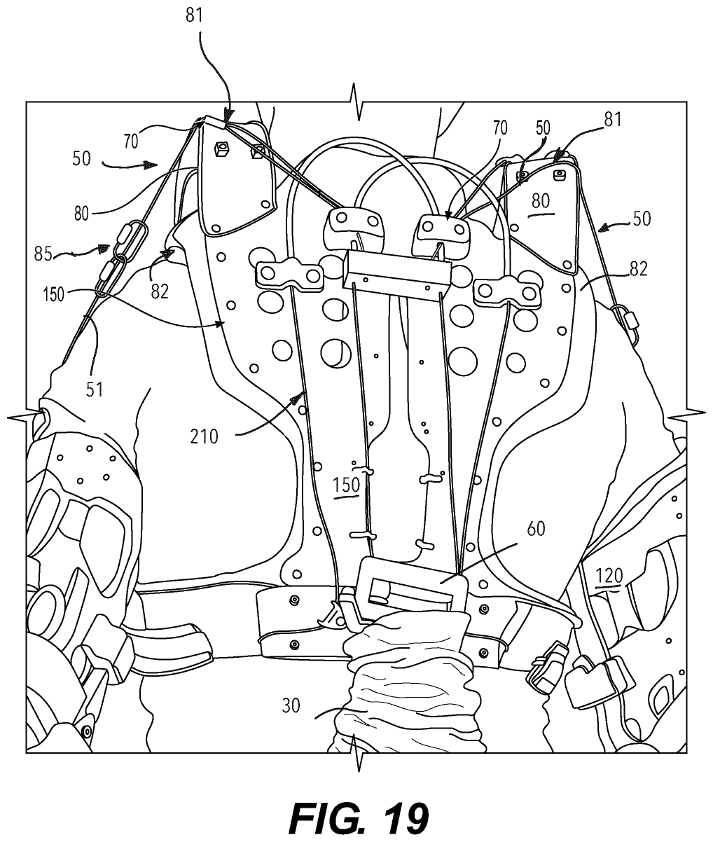

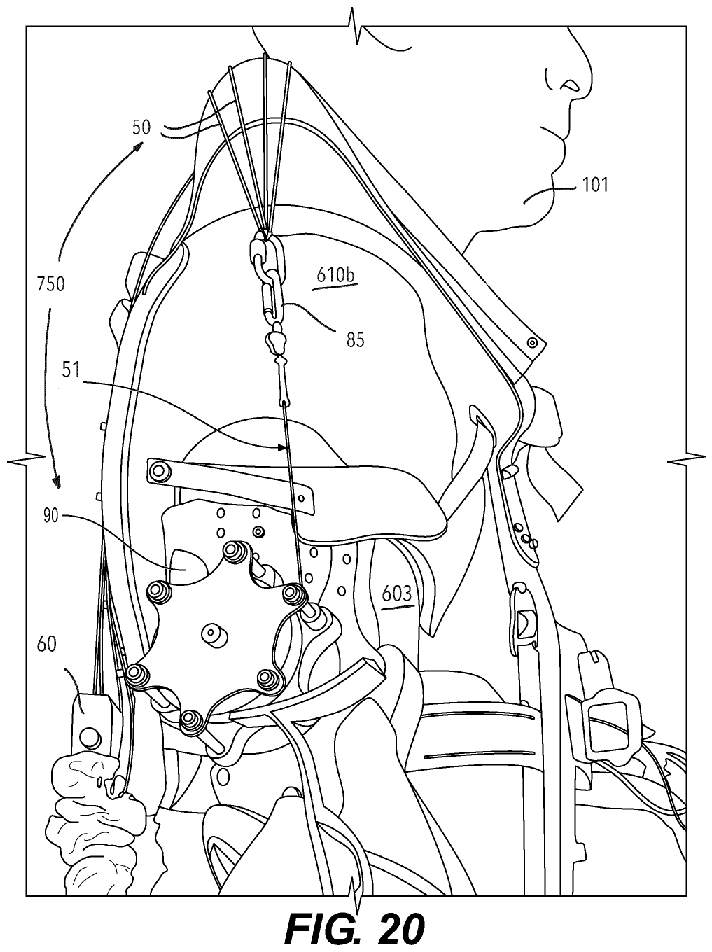

The tension cable system 40 is depicted in detail in FIGS. 19 and 20, in accordance with at least one embodiment of the present disclosure. The tension cable system 40 is connected to the connector 60 and comprises tension cables 50 extending upward from the connector 60, toward each arm 603 of the user 101. Each arm 603 is decoupled from the other arm 603. Each arm has its corresponding arm tension cable 51 which, in some embodiments, may be one of the tension cables 50.

Preferably, the material for the tension cable(s) of the tension cable system 40 is made of high strength materials such as UHMWPE or aramid cables in order to be able to withstand and transfer the loads applied on the exoskeleton 100.

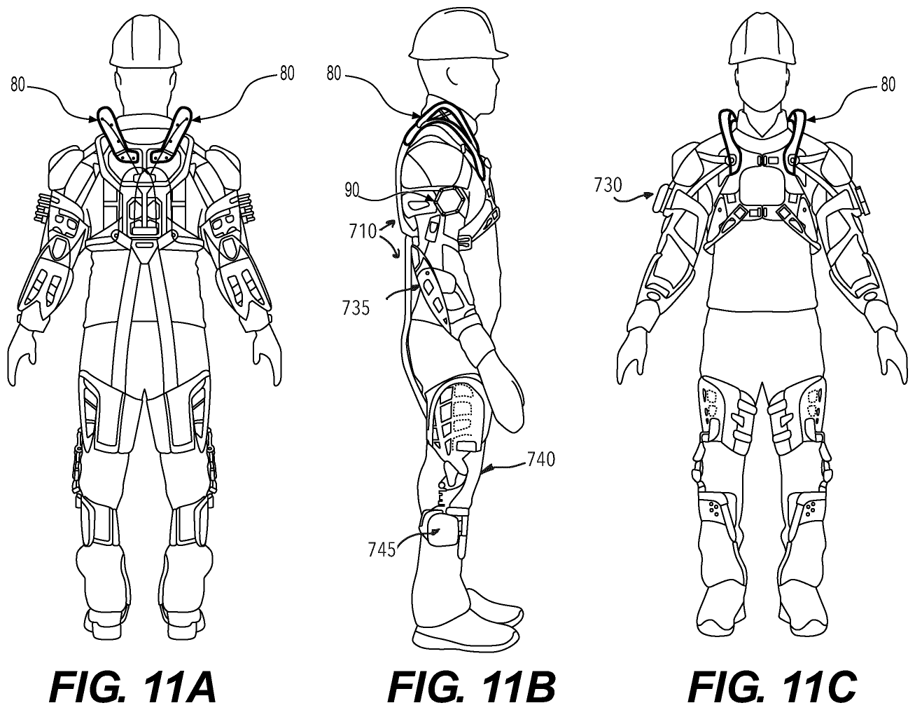

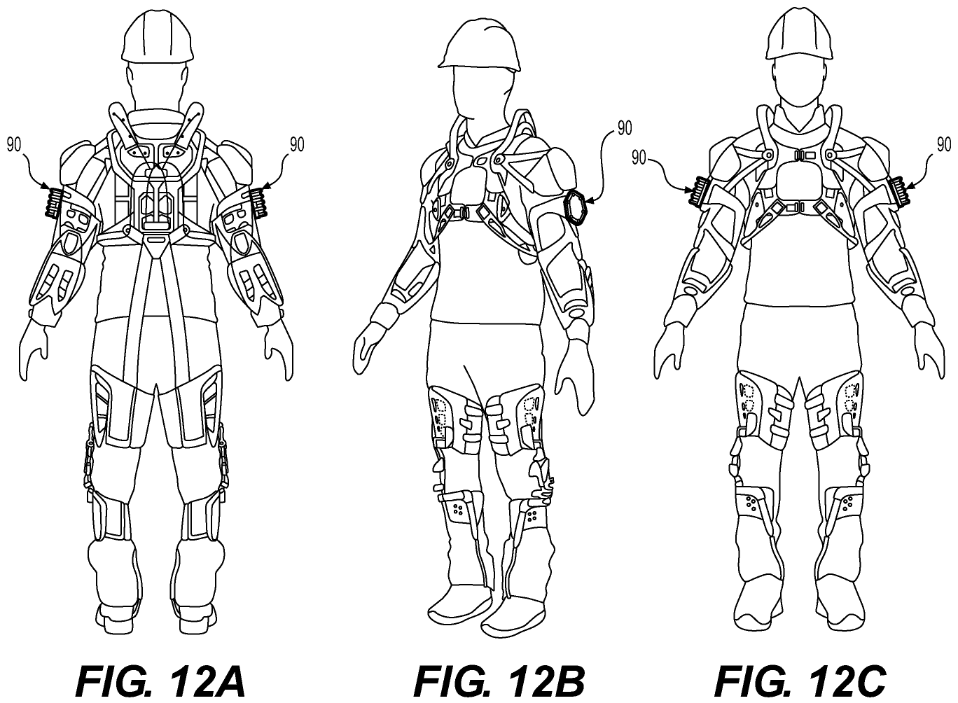

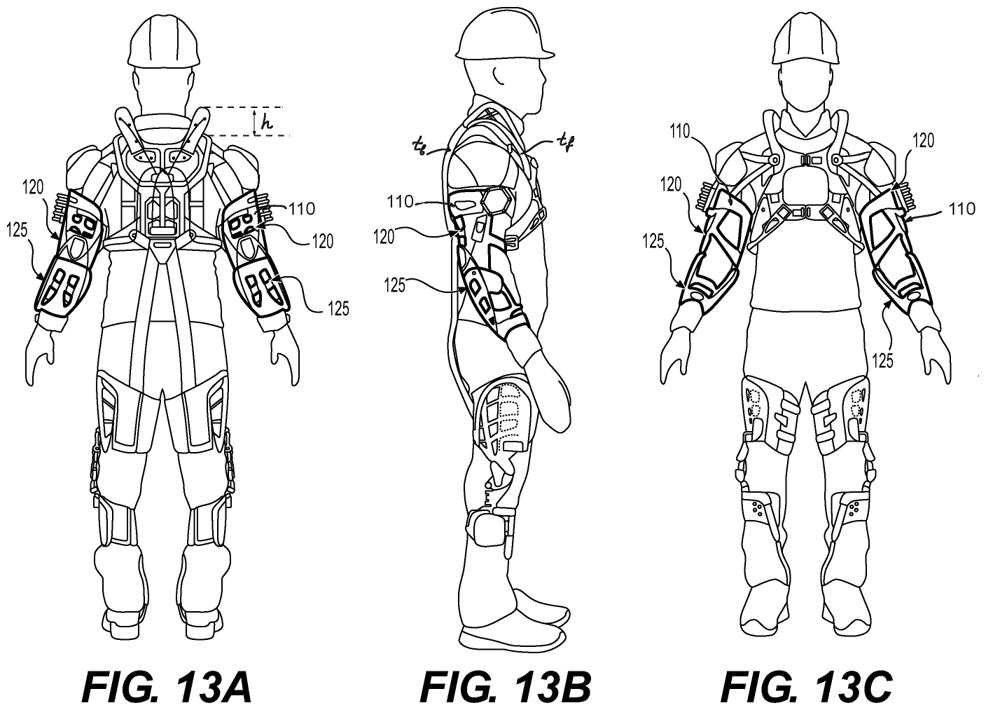

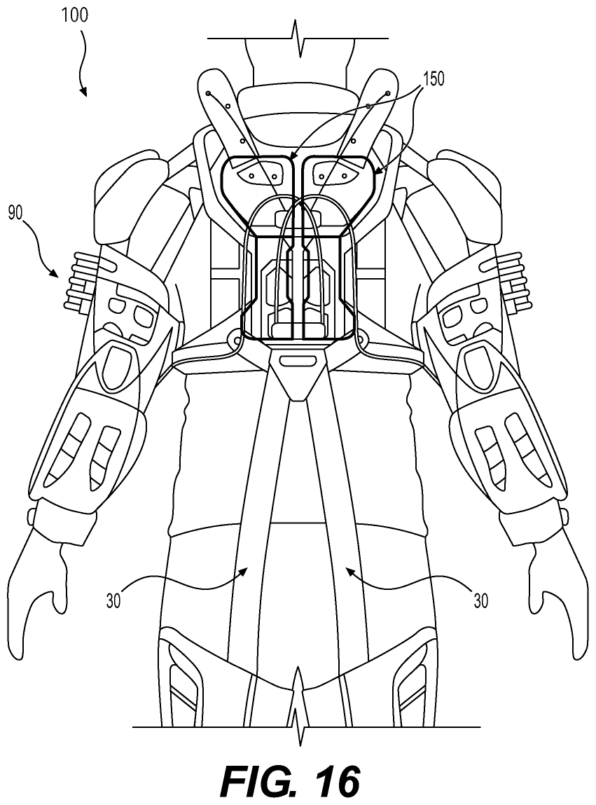

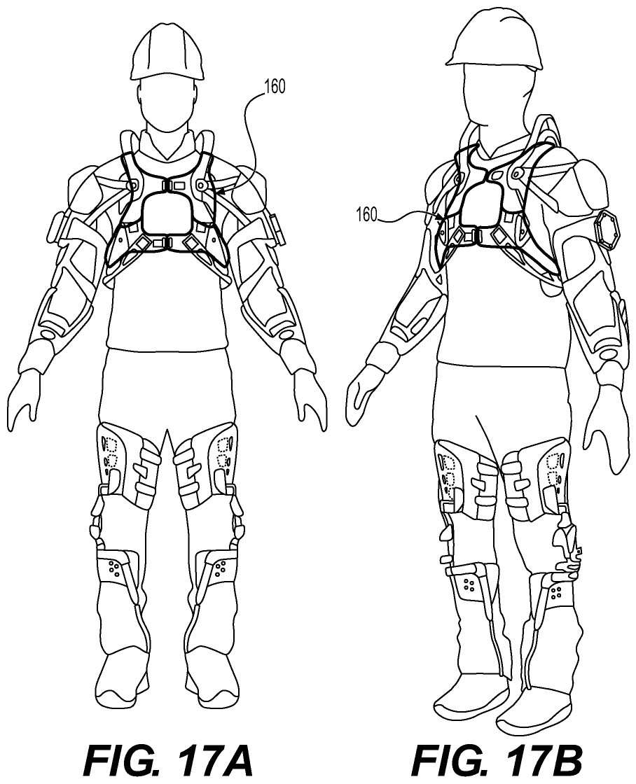

The exoskeleton 100 further comprises a pair of shoulder bridges 80 (shown on FIGS. 11A, 11B and 11C), each being connected to a back structural plate 150 (see, e.g. FIG. 16) in the back and to a front harness 160 in the front (see, e.g. FIGS. 17A, 17B). The exoskeleton 100 further comprises a disengageable shoulder clutch system 90 (shown on FIGS. 12A, 12B, 12C, 20) to be preferably positioned on each upper arm of the user and attached to the arm structure 110 of the exoskeleton 100 (FIGS. 13A-13C).

Preferably, the arm structure 110 of the exoskeleton 100 is made of high strength polymeric materials, such as carbon fibers reinforced composite materials, nylon, onyx, ABS, or the like.

Referring to FIGS. 19 and 20, preferably, the tension cables 50 of the tension cable system 40 are configured to pass inside cable guides 70 up to the shoulder bridges 80 and then connected to the shoulder clutch system 90 (see, for example, FIG. 19). Hence, the shoulder bridges 80 are structural elements that allow to offset the tension cables 50 of the tension cable system 40 at the shoulder level and to reroute the tension cable 50 of each arm (arm tension cable 51) of the tension cable system 40 from an elevated position down in the arm structure 110 and/or shoulder clutch 90 (FIG. 13A, 13C), thus increasing the lever arm for the actuation of the shoulder and avoiding or minimizing the contacts with the exoskeleton structure and user's shoulder. In at least one embodiment, the shoulder bridges are elevated above the user's shoulder and are configured to reroute the tension cables towards an arm harness.

Referring also to FIGS. 19 and 20, each shoulder bridge 80 has an upper shoulder bridge surface 81 which rises above the user's shoulder 610a, 610b. A shoulder bridge height h is a distance between the user's shoulder and the highest portion of the shoulder bridge 80 or of the elevated upper shoulder bridge surface 81.

In at least one embodiment, the shoulder bridges 80 are made of polymer material shaped in a convex shape to increase their rigidity. Tubular members, not illustrated, or other structures could alternatively be used without departing from the scope of the present description. The shoulder bridges 80 are connecting the back structural plate 150 to the front harness 160 to allow the exoskeleton 100 to sit on the user's shoulders. An inverted “U” shape may be appreciated from FIG. 11B to interconnect in a rather rigid manner to provide support for the tension cables that are rerouted towards the arm harness, arm module (which comprises the arm harness and the shoulder clutch system 90), and/or another module of the exoskeleton 100. An elevated, with regard to the user's shoulder, and rigid structure of the shoulder bridges 80 assists to form the myofascial tension line together with one of the elastomeric elements (such as the back elastomeric element 30, for example) as described herein. In at least one embodiment, the tension cables are rerouted towards the arm harness via the shoulder clutch system.

In at least one embodiment, the shoulder bridge height h is larger by an additional height Δh than a thickness t_{f} of the front harness and/or than a thickness t_{b} of the back structural plate 150. For example, the shoulder bridges may be at least twice thicker than the thickness of the back structural plate 150. In another example, the additional height of the shoulder bridges may be at least three times thicker than the thickness of the back structural plate 150. The shoulder bridge height h (in other words, the longest distance between the elevated upper shoulder bridge surface 81 and the shoulder-engaging surface 82) may be at least distanced from the top of the shoulders of the wearer, for example, in an unillustrated embodiment, more than about 1 centimeters, in other embodiments preferably more than about 5 centimetres, more precisely between about 5 and 10 centimetres, alternatively between about 7 and 10 centimetres, between about 7 and 15 centimetres, between about 7 and 12 centimetres.

Shoulder bridges may be various heights. The higher the shoulder bridge, the more chances that it interacts with the head of the user in certain positions. Also, if the shoulder bridge is too high, it will restrict the movement of the shoulder because the shoulder bridge may touch the neck or the head of the user when the user raises the arms. On the other hand, the shoulder bridge needs to be high enough to direct the cables to the shoulder clutch without contacting the shoulder of the user.

Such additional height results in the elevated position of the elevated upper shoulder bridge surface 81 of the shoulder bridges 80, with respect to the user's shoulders, for the tension cables 50 of the tension cable system 40. The additional height Δh and therefore the additional elevation of the shoulder bridges 80 over the user's shoulders help increasing the lever arm for the arm tension cable and allowing to avoid or minimize contacts with both the user's shoulder and the exoskeleton arm structure and harness.

In some embodiments, the shoulder bridges 80, in addition to the elevated upper shoulder bridge surface 81 have a shoulder-engaging surface 82. The shoulder-engaging surface 82 engages with (in other words, hangs on or sits on) the user's shoulder 610a, 610b. In such embodiments, the shoulder bridge height h is the longest distance between the elevated upper shoulder bridge surface 81 and the shoulder-engaging surface 82.

In a preferred embodiment, the tension cables 50 passing above and over shoulder bridges 80, are multiplied into a bundle, in other terms, into several tension cables 50 (see FIG. 20), to ensure a better distribution of the forces on the shoulder, to then regroup in a single tension cable referred to herein as an arm tension cable 51. The arm tension cable 51 may be winded up in the disengageable shoulder clutch system 90. In some embodiments, the arm tension cable 51 may be connected using one or more hook connectors 85, such as, for example, carabiner hooks or snap hooks.

Preferably, each shoulder bridge 80 has a rigid elevated upper shoulder bridge surface 81 and at least a portion of the shoulder bridge 80 is rigid to support a constant height of the elevated upper shoulder bridge surface 81 relative to the shoulder-engaging surface 82 and/or the user's shoulder 610.

In at least one embodiment, the arm tension cable 51 is connected to a shoulder clutch system 90. The arm tension cable can be winded inside the clutch structure or unwinded outside the clutch structure. Torque is applied inside the clutch system by an elastic medium, such as an elastomer or torque spring, to keep a small tension on the arm tension cable 51 which facilitates cable winding inside the clutch (reduction in length of the arm tension cable 51) or cable unwinding outside the clutch (increase in length of the arm tension cable 51). The shoulder clutch system 90 can be blocked (no more winding or unwinding of the arm tension cable 51) manually or by other means, to fix the arm tension cable length.

In an embodiment, the shoulder clutch 90 uses a ratchet and pawls mechanism to allow free rotation and then to lock the clutch and block arm cable winding (to put the shoulder clutch 90 in a so-called “lock mode”).

The shoulder clutch system is connected to the arm harness and an arm structure, the arm tension cable is connected to the shoulder clutch system and configured to be reeled inside the clutch structure, such that when the clutch system is activated, the clutch system is configured to block the arm tension cable winding, and, in turn, to fix the arm tension cable length. When engaged, the clutch system allows the user, by moving downward the user arms to pull on the back elastomeric element to get support at the shoulder level and also to use the potential energy stored in the elastomeric element to lift and handle an object. When deactivated, the arm tension cable may be reeled inside the clutch structure and the arm is not restricted in its movement.

As shown on FIGS. 13A-13C, the exoskeleton 100 may further comprise arm harnesses 120 and forearm harnesses 125 for each arm 603 of the user 101, configured to be located at the upper arms 603 and forearms 605a, 605b, respectively, for distributing the pressure applied by the MTL 350 onto an extended arm surface.

Each arm harness 120 and forearm harness 125 provides a firm interface with the geometry of the user's arm regions. While providing a firm lock, the arm harness 120 and forearm harness 125 are sufficiently supple to adhere to slight morphological variations and to spread loads throughout the user to arm regions (upper arm and forearm, respectively).

In an embodiment, the arm harnesses 120 and forearm harnesses 125 are composed of a 3D shape assembly, composed of thin Nylon (or other polymeric materials, such as PLA) flat pattern strands and assembled by rivets to mimic precisely the arm geometry.

The arm harness 120 is configured to receive at least a portion of the user's arm. For example, the arm harness 120 may be fastened on the user's arm to surround at least a portion of the arm 603 such that movement of the arm 603 results in a movement of the arm harness 120. Similarly, the forearm harness 120 is configured to receive at least a portion of the user's forearm 605a, 605b. For example, the forearm harness 125 may be fastened on the user's forearm 605a, 605b to surround at least a portion of the forearm 605a, 605b such that movement of the forearm 605a, 605b results in a movement of the forearm harness 125.

In some embodiments, the exoskeleton 100 may have one or two (one for each arm) arm harnesses 120 but not the forearm harnesses 125. In some embodiments, the exoskeleton 100 has two arm harnesses 120 and one or two forearm harnesses 125. In some embodiments, the exoskeleton 100 has one arm harness 120 and one forearm harnesses 125. The forearm harness 125 may be added to already existing exoskeleton 100 which does not have the forearm harness 125. Thus, the exoskeleton 100 may have a modular structure and additional modules, such as forearm harness 125, as well as calf harness 135 and/or knee actuation system 140 (described below) may be added to or removed from the exoskeleton 100 to adjust the exoskeleton 100 to various needs.

In at least one embodiment, each arm harness 120 is coupled to the shoulder clutch system 90. The elbow elastomeric element 220 is also coupled to the arm harness 120. In at least one embodiment, the elbow elastomeric element 220 has a plurality of pivot points 1000 defining routing of an elbow tension line 355 located on the arm 603 and forearm 605, such that when moving the elbow of the user, a potential energy is stored in the elbow tension line 355 for using this second potential energy for moving objects with the user's arm.

The forearm harness 125 may be coupled to the arm harness 120 and may be connected to the elbow elastomeric element 220 and to the arm harness 120.

In at least one embodiment, the exoskeleton 100 as shown on FIG. 16, comprises a back structural plate 150, which is preferably a rigid composite structural element configured to be positioned in the user's back to support the connector 60 and define the routing of the tension cables 50 of the tension cable system 40 through the cable guides 70. The shoulder bridges 80 are also configured to be attached to the back structural plate 150.

In at least one embodiment, the exoskeleton 100 as shown on FIGS. 17A-17B, comprises a front harness 160 configured to support the other end of the shoulder bridges 80, preferably made of flexible materials (e.g. textiles) and semi-rigid and rigid materials (e.g. polymeric materials). The exoskeleton 100 may also contain attaching elements to don and doff the system (in other words, putting on and off) at the chest level, as well as for the arm and forearm harnesses 120, 125.

The exoskeleton 100 also comprises the pre-tension cable system 210 coupled to the back structural plate 150, the connector 60 and the back elastomeric element 30, and the pre-tension cable system 210 allows to set an initial tension into the back elastomeric element 30.

In an embodiment, the pre-tension (in other terms, an initial tension) of the back elastomeric element 30 is preferably set manually, and is preferably performed by the pre-tension back cable system 210 (also referred to herein as an “integrated cable system for pre-tension 210” and shown in FIGS. 2A, 2B and 2C) integrated to the exoskeleton structure (here at the floating rib level). The pre-tension back cable system 210 allows to translate vertically, upward or downward, the connector 60 (the maximal length of the translation may depend on the anthropometry of the user), for adjusting (increasing or decreasing) the tension of the elastomeric elements 30, hence allowing for adjustment of the pre-tension in the back elastomeric element 30.

In at least one embodiment, the pre-tension back cable system 210 is coupled to the front harness 160 of the user, at least one cable guide 70 attached to the back structural plate 150, and a connector 60 attached to the back elastomeric element 30, the pre-tension cable system 210 is configured to adjust an initial tension in the back elastomeric element 30.

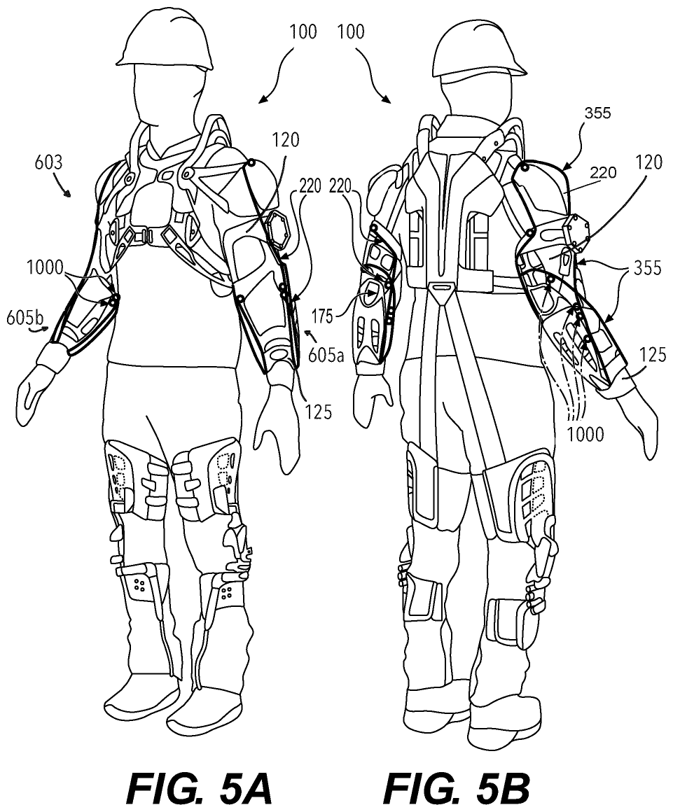

In an embodiment, as shown in FIGS. 5A and 5B, the exoskeleton 100 may further comprise elbow joints 175, the actuation thereof being preferably done by a bio-inspired elbow tension line 355 that is defined and formed by a complex routing of an elbow elastomeric element 220 onto the arm harness 120 and forearm harness 125. The complex routing allows to benefit of a longer elbow elastomeric element 220, hence accumulating potentially more energy. The complex routing of the arm/elbow elastomeric element 220 may be achieved, for example, by several passages of the arm/elbow elastomeric element 220 along the same length of the arm and forearm. In other terms, the arm/elbow elastomeric element 220 may have several branches located parallel to each other and along the same length of the arm and forearm. For example, the arm/elbow elastomeric element 220 may form a network with at least two portions running parallel to each other along the lengths of the arm and the forearm. The initial tension applied to the elbow elastomeric element 220 may be adjusted by the user to vary the assistance provided by the elbow tension line 355.

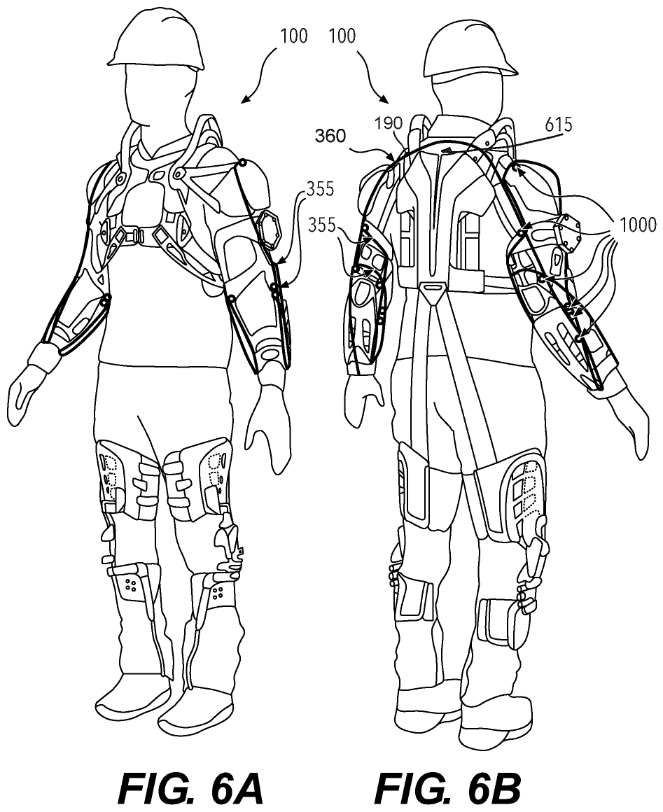

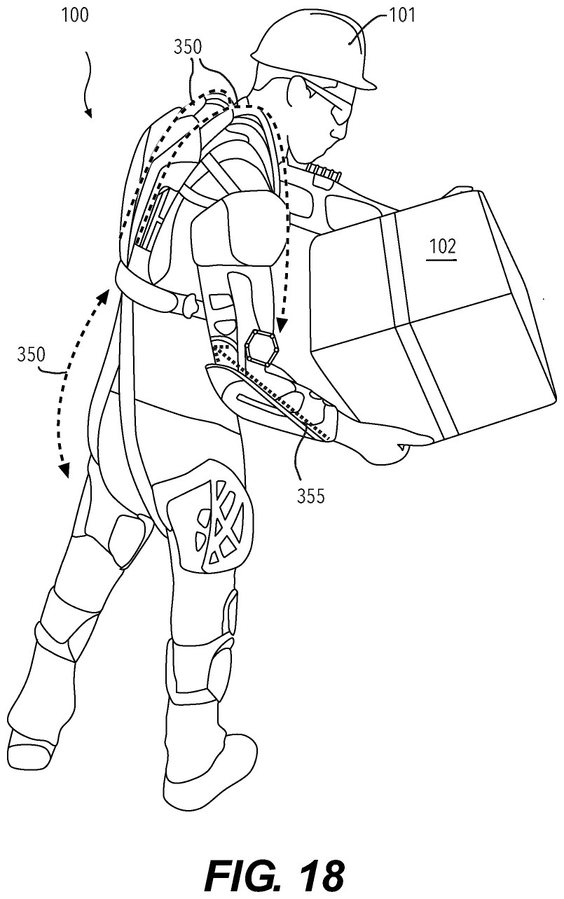

In an embodiment, each arm has its own elbow joint 175 and elbow tension lines 355 of the elbow elastomeric element 220 (as illustrated in FIG. 18). To reduce friction with the elbow elastomeric element 220 of the elbow tension line 355, several pivot points 1000 highlighted in FIGS. 5A, 5B, 6A-6B (with low friction hardware such as bearings or bushings) are connected to the arm structure 110 and the back structural plate 150 of the exoskeleton 100. The pivot points 1000 define the routing of the elbow tension line 355 on the structure of the exoskeleton 100. When moving the elbow, the user stores potential energy in the elbow tension line 355 and this energy is used to lift, support and/or handle objects or tools.

In an embodiment depicted in FIGS. 6A and 6B, another bio-inspired tension line, referred to herein as “arm tension line 360” performs the actuation of the elbow joint 602 of the user 101. In other words, the actuation of the elbow joint 602 of the user 101 is performed along the arm tension line 360. This arm tension line 360 is formed by an inter-arm elastomeric element 190 that runs from the left forearm 605a up to the left shoulder 610a, then in the upper back region 615 (routing preferably ensured by cable guides 70 and pivot points 1000) and then goes in the right shoulder 610b down to the right forearm 605b. The initial tension applied to the inter-arm elastomeric element 220 can be adjusted by the user to vary the assistance provided by the arm tension line 360.

The inter-arm elastomeric element 190 is configured to actuate the elbow of the user. In at least one embodiment, the inter-arm elastomeric element 190 does not use the clutch system described herein. The shoulder clutch system 90 as described herein is configured to engage the assistance of the shoulder. Without the clutch system 90, the arms of the user would always be under the tension because they would be connected to the back elastomeric element 30. The clutch system 90 permits to disengage the arms (and the forearms) in order to decouple them from the back elastomeric element.

In at least one embodiment, the exoskeleton 100 may have no clutch system as described herein, and in such an embodiment, the arms would be connected to the back elastomeric element 30 and therefore the arms would be restricted in movement by the tension in the back elastomeric element 30.

In at least one embodiment, the back elastomeric element 30, elbow elastomeric elements 220 and inter-arm elastomeric element 190 have stiffness of approximately 785 Newton/meter (N/m). In some embodiment, at least one of the back elastomeric elements 30, elbow elastomeric element 220 and inter-arm elastomeric element 190 has stiffness of approximately 785 Newton/meter (N/m). The stiffness may vary and/or be adjusted for different users depending, for example, on user's muscles' strength.

In an embodiment, the shoulder clutch system 90 is to be positioned on each arm of the user, and the shoulder clutch system 90 comprises a ratchet and pawls mechanism to allow upward movement of the arms and to block movement downward. The shoulder clutch system 90 which is in a lock mode can be deactivated (by releasing the tension cable 51 of the tension cable system 40 and allowing the arms to return to their normal state) by a button that disengages the ratchet and pawls mechanism.

In at least one embodiment, the inter-arm elastomeric element 190 runs from one arm and forearm harnesses 120, 125 to another arm and forearm harnesses 120, 125 through the back of the user 101 and forms the arm tension line 360 (FIG. 6B).

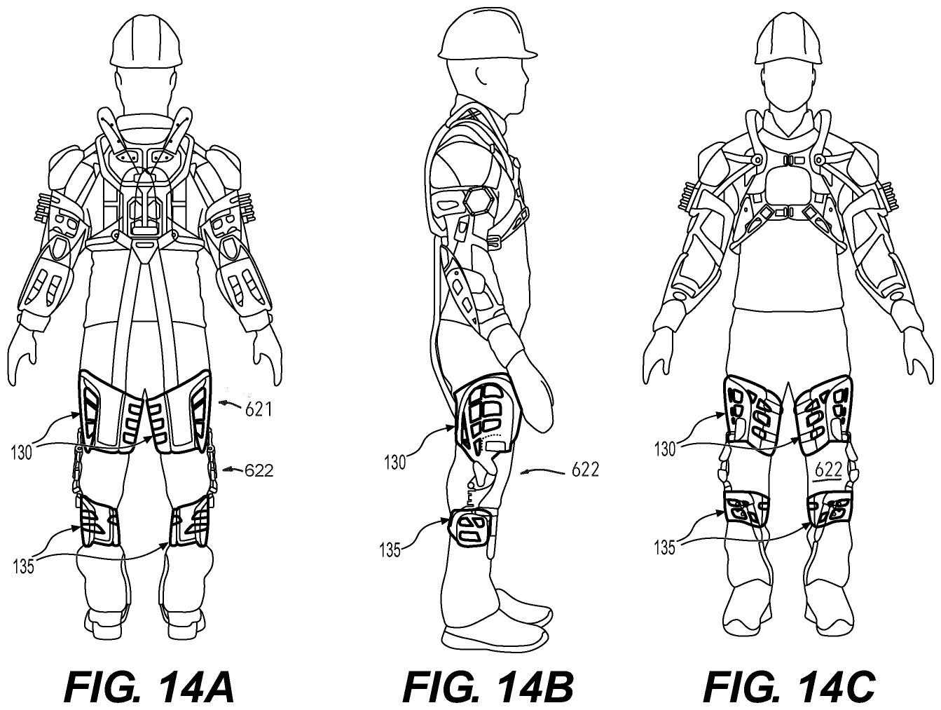

As aforesaid, the exoskeleton 100 as shown on FIGS. 14A-14C, may further comprise a pair of thigh harnesses 130, and optionally a pair of calf harnesses 135, preferably made of the same system/material as the arm harnesses 120.

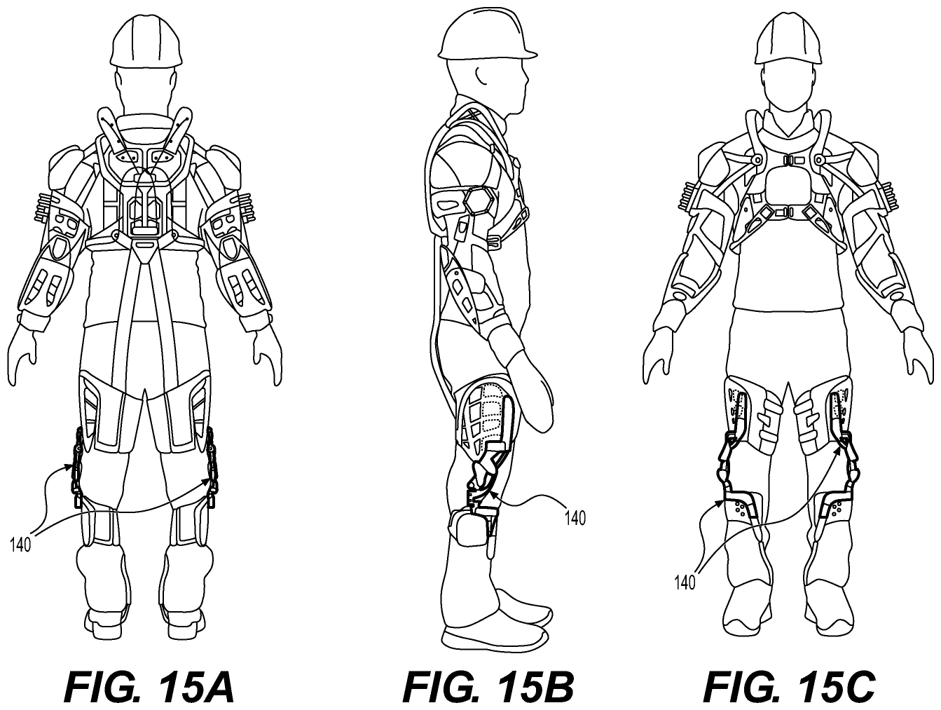

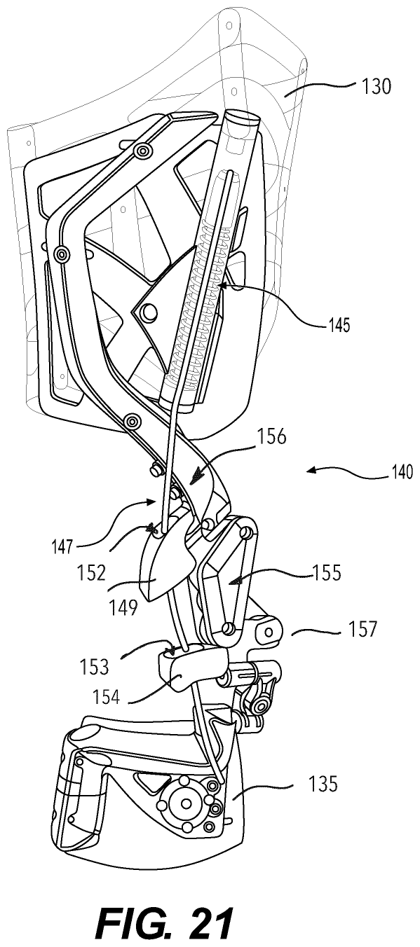

In an embodiment where the knee is not coupled to the MTL 350, a knee actuation system 140 may be provided. The knee actuation system 140 is highlighted in FIGS. 15A, 15B, 15C. As shown in FIG. 21, the knee actuation system 140 may comprise a knee cable 147, such as, for example, a Bowden cable (also referred to herein as a “Bowden cable 147”), for applying a force (tension or compression) on a spring mechanism 145 or other elastic medium when the knee is bent. In other words, the knee actuation system 140 comprises the spring mechanism 145 coupled to the knee cable 147 configured to compress or expand the spring mechanism 145. The knee actuation system 140 may be coupled to the thigh harness 130 and the calf harness 135. In at least one embodiment, the calf harness 135, when present, is configured to receive and adhere to a portion of a user's calf. The calf harness 135 may be coupled to the thigh harness 130 via the knee actuation system 140.

The Bowden cable 147 is connected on one side to a moving part (with respect to the thigh harness 130) of the exoskeleton leg structure (for example, calf harness 135) and on the other side to the spring mechanism 145. For example, as illustrated in FIG. 21, the knee cable 147 may pass through one or more cable guides 152 in the knee joint structure 149 (and additional cable guides 153 in element 154) to avoid any contacts with (and to be stuck in or to be blocked in) the knee joint mechanism and reach to the calf harness 135 to be attached to the calf harness 135. The spring mechanism 145 itself may be attached to the thigh harness 130.

The calf-thigh connector 155 is a structure of the knee joint. The knee structure comprises at least two mobile elements that connect to each other and act as the Four-bar mechanism such that the knee works similar to a human's knee (rotation movement coupled with the translation movement).

When the knee is bent, the Bowden cable 147 applies a force and extends or compresses the spring mechanism 145 (or other elastic medium, compression, or tension springs) in order for the spring to store potential energy that will be used to assist the user's knee and leg when returning in upright position. In some embodiments, the spring mechanism 145 may have a spring with a spring return constant of approximately 9.4 Newton/millimeter (N/mm). The spring return constant may vary and/or be adjusted for different users depending, for example, on user's muscles' strength.

To ensure that the user 101 can walk with the exoskeleton 100, the Bowden cable 147 is configured to only activate the main spring mechanism 145 when it has passed a defined knee flexion angle which is variable depending on the user's natural flexibility, morphology and the type of tasks performed.

A weaker spring (not shown) may also be connected to the Bowden cable 147 to ensure the Bowden cable is slightly tensioned when the knee actuation system is not activated (e.g. when in upright position or before reaching the defined knee initial angle). This may be done to avoid any interaction between the knee mechanism and the Bowden cable.

In a preferred embodiment, the knee's spring mechanism 145 is configured to be positioned onto the thigh harness 130 closer to user's center of gravity, thus reducing the user's energy cost in locomotion.

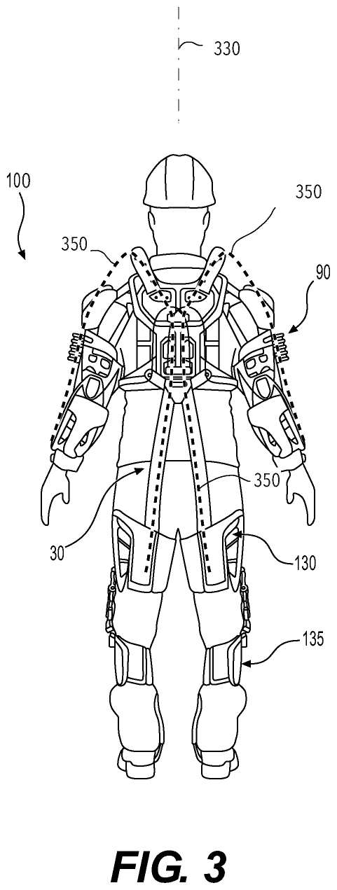

Referring to FIG. 3, in at least one embodiment, the exoskeleton 100 may further comprise a knee actuation system 140 as aforesaid, where the knee of the user 101 may be actuated using the MTL 350. For example, the back elastomeric element 30, extending downward down to the knee, may be coupled to the calf harness 135 or tension cables connected to the calf and or thigh harnesses are utilized to use the tension in the back elastomeric element 30 to actuate the user's knee joint.

As mentioned above, in at least one embodiment, the exoskeleton 100 is modular. The exoskeleton 100 may have one or more modules. Various modules of the exoskeleton 100 may be, for example: a back module 710, a shoulder module 730, an elbow module 735, a knee module 740, an ankle module 745 (FIG. 11A-11C), a tension cables module 750 (FIG. 20).

The back module 710 may comprise, for example, the back elastomeric element 30 coupled to a thigh harness 130 positioned on a thigh of the user. As described herein, such configuration may provide the benefit of forming the artificial myofascial tension line while there is no or very little weight that is posed on the user's thighs. The back module 710 may also comprise the back structural plate 150, to which the back elastomeric element 30 may be coupled and also the pre-tension cable system 210 to set an initial tension into the back elastomeric element 30.

A tension cables module 750, which comprises the tension cable system 40 attachable (or otherwise coupled) to the back elastomeric element 30 may be coupled to the shoulder module 730 and/or an elbow module 735. In at least one embodiment, the shoulder module 730 comprises also the tension cables module 750 such that tension cables 50 are used to connect the shoulder clutch system 90 with the back elastomeric element 30.

The shoulder module 730 may comprise, for example, the arm harness, the shoulder bridges 80, the pre-tension cable system 210 and the shoulder clutch system 90.

The elbow module 735 may comprise the forearm harness, the arm harness 120, the arm structure 110 and the elbow elastomeric element 220 (and/or the inter-arm elastomeric element 190). The elbow module 735 may also comprise the elbow joint 175. For example, the elbow module 735 may be coupled to the shoulder module 730.

The ankle module 745 may comprise the calf harness and elements for coupling to the thigh harness of the back module 710. The knee module 740 may comprise the knee actuation system 140, the knee joint 149 and elements for modular connection to the thigh harness and/or ankle module. Due to such modular structure, the exoskeleton 100 may be adjustable for various needs of the user. Each module may have various attachments to be used for coupling (or attaching) to the other modules.

Without limitation, the exoskeleton 100 as described herein may apply to masonry, construction, logistics and handling of heavy tools and equipment.

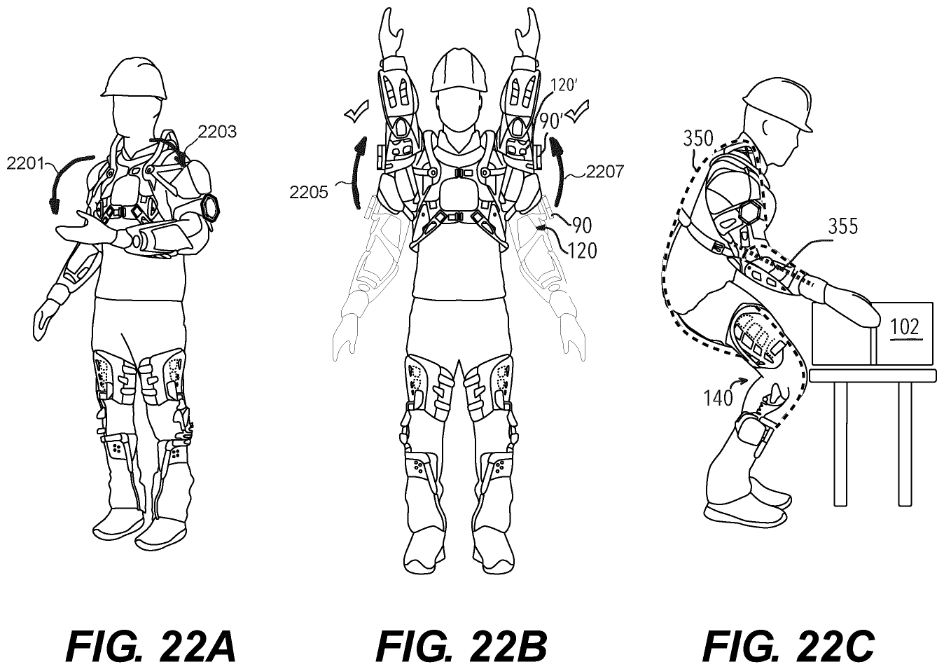

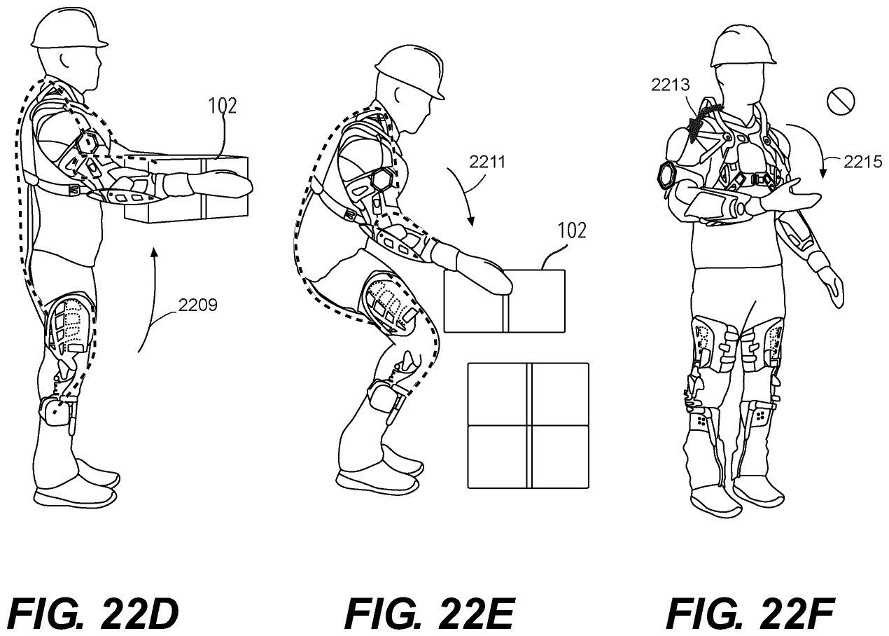

The exoskeleton 100 as described herein may be worn by the user 101 and used when the user 101 is handling an object 102 (see, for example, FIGS. 22A-22F). The “handling” of the object 102 as referred to herein may comprise lifting, supporting, carrying, moving, etc.—any activity (or action) of the user that requires the user to displace the object 102 or otherwise manipulate the object 102. Such activity may involve lifting, moving and/or carrying the object 102. The technology as described herein may be used when the object 102 is relatively heavy compared to physical capabilities of the user 101, and/or require efforts by the user 101 to handle such an object 102.

In operation, using the tension cable system 40 jointly with the elastomeric elements 30, the exoskeleton 100 allows to actuate simultaneously or individually the knee, back, shoulder and/or elbow, as requested by the user when he/she is lifting and/or handling an object or a tool. In at least one embodiment, the back and the shoulders only may be actuated by the tension cable(s) 50 (tension cable system 40) and the back elastomeric element 30.

The operation of the exoskeleton 100 relies on the use of elastomeric elements 30 and/or other elastic mediums (e.g. springs) that can store mechanical energy, acting as an accumulator of potential energy, which can be redistributed and used, according to the needs of the user 101, in one or the other of user's limbs, according to the needs of its kinematic chain. In at least one embodiment, the operation of the exoskeleton 100 relies on enforcing and imitating operation of muscular groups and fascia located along the back functional line of the user's body.

The distribution of potential energy is carried out by a network of non-elastic tension cables 50 (the arm tension cable 51 being one of a plurality of the tension cables 50). In at least one embodiment, the arm tension cable 51 is coupled to the back structural plate 150 via the plurality of tension cables 50. Each tension cable of the plurality of tension cables 50 may be slidably coupled to the back structural plate 150 and slidably coupled to one of the shoulder bridges 80, for example, through cable guides 70. Such cable guides 70 may be immovably attached to the back structural plate 150.

The relation between the potential energy stored in an elastomeric element and its elongation is: E=½ Kx², where x is the elongation of the elastomeric element and K its spring constant (based on Hooke's law). This squared relation of stored energy to the elongation reflects the importance of the length (which allows for greater elongation), when aiming at a high storage capacity for potential energy when using an elastomeric element.

The biomimetism of the present technology is to draw inspiration from the network of fascia present in the human body, which acts as elastics which, when an agonist muscle contracts (e.g. biceps), when it stops contracting, the fascia act as an elastic body allowing to return to the initial position, without any further effort, thus substantially lowering the metabolic expenditure of the user.

FIGS. 3, 7A, 7B, 9A, 9B, 9C, 18, 22C, 22D, and 22E illustrate with dotted lines an exoskeleton actuation system of the exoskeleton 100 composed of tension lines: the myofascial tension line 350 and the elbow tension line 355 (also referred to herein collectively as “tension lines 350, 355”). The myofascial tension line 350 is formed by such elements of the exoskeleton 100 as the back elastomeric element 30 and tension cables 50. The elbow tension line 355 is formed by the elbow elastomeric element 220 connected to the forearm harness 125 and arm harness 120. The arm tension line 360 is formed by the inter-arm elastomeric element 190, the arm harnesses 120 and forearm harness 125. The tension lines 350, 355 and 360 formed in the exoskeleton 100 are configured to activate several groups of muscles of the user 101 at the same time according to the movements of the user 101. Such tension lines 350, 355 and/or 360 cover a large part of the user's body and assist different muscles depending on the user's needs and on the exoskeleton configuration. The fact that the main back elastomeric element 30 is connected to a cable system (i.e. the tension cable system 40), which itself is connected to the shoulder clutch system 90 and arm harness 120 (which is fastened to the user's arm 603) makes this type of actuation efficient and versatile.

The exoskeleton 100 described herein does not need to rely on pushing on to and the weight support by thighs 621 of the user 101 because the operation of the exoskeleton 100 is based on following the user body's back functional line and on reproducing (forming) the artificial myofascial tension line. The exoskeleton 100 as described herein uses a connection between the legs and the back, as provided by the back functional line. The exoskeleton 100 as described herein is passively actuated by the combination of the back elastomeric element 30) and tension cables system 40 along user's myofascial line to form the artificial myofascial tension line. In some embodiments, the exoskeleton 100 as described herein is passively actuated along the elbow tension line 355 or arm tension line 360 as described herein. The exoskeleton 100 as described herein may be defined as a myofascial passively actuated exoskeleton.

As an example, FIG. 18 depicts the user 101 lifting and otherwise handling an object 102 (such as, for example, a package).

The shoulder clutch system 90 is engaged and therefore the MTL 350 is used to support part (or all) of the object's weight at the shoulder level. The tension cable system 40 pulls on the connector 60, then on the elastomeric elements 30 and tension builds up in the tension cable system 40, and such tension built in the tension cables 50 assists the user 101 at the back and shoulder level to lift, support and handle the object 102.

Thus, based on the pre-tension previously applied to the back elastomeric element 30 and by the weight of the handled object, the force generated by the back elastomeric element 30 is transferred to the shoulder bridge 80 and then to the arm by means of the tension cable system 40.

As a further embodiment, and as it appears also in FIG. 18, an additional elbow tension line 355, embodied by the elbow elastomeric elements 220 (see FIG. 5A, 5B) may be provided for, and used to generate a torque to facilitate the handling of the object 102 (such as, for example, a package), when using the biceps muscle: the torque generated at the elbow by the elongation of the elbow elastomeric element 220 assists the user. In FIGS. 5A, 5B, the elbows are actuated by the elbow elastomeric elements 220.

The back elastomeric element 30 is used to store potential energy in order to assist the user 101 when performing specific lifting, handling or carrying tasks. For instance, when the user 101 is leaning forward, the elastic medium of the elastomeric elements 30 stores potential energy and restores it to the leg, arms and the back of the user 101 when the user returns in the upright position, as the back functional line of the human body would do.

Referring to FIGS. 20 and 22B, when the user lifts his/her arm for activating the exoskeleton 100, the arm tension cable 51 (which is one of the tension cables 50 of the tension cable system 40) is rolled in the shoulder clutch system 90 and the length of the arm tension cable 51 is shortened. The shoulder clutch system 90 is blocked as soon as the user stops lifting his/her arm and applies a vertical downward force on the arm tension cable 51. When the arm tension cable 51 is blocked by the shoulder clutch system 90, the arm tension cable 51 pulls on the connector 60 which in turn pulls on the back elastomeric elements 30 (highlighted, for example, in FIGS. 1A, 1B) to actuate the shoulder 610. The arm tension cable 51 can now support the arm's weight as well as assist the user 101 when lifting and supporting objects with the shoulder. For instance, when the user 101 lifts the arm with an object 102 in the hands (as illustrated in FIG. 18), the shoulder movement is supported by the tension in the back elastomeric elements 30 and the potential energy stored in the back elastomeric element 30 can be used to facilitate the lifting/handling of the object and thus is passively actuated by the MTL 350. A similar phenomenon occurs when the user performs a movement of the elbow.

As a further example, in FIG. 22A, the user manually activates shoulder assist clutches 90 (also referred to herein as “shoulder clutch system 90”). To activate the shoulder assist clutches, the user may, for example, manually rotate an arm of the ratchet and pawls mechanism.

In FIG. 22B, the user lifts his arms to reel the arm tension cables 51 into the shoulder clutch 90. User then descends arms to block the shoulder clutch 90 (in other terms, to bring the shoulder clutch 90 to the lock mode). Arrow 2205 illustrates an upward movement of the left arm. Arrow 2207 illustrates an upward movement of the right arm.

In FIG. 22C, the user bends forward his back and flexes is knees to store additional potential energy in the myofascial tension line 350 (an initial tension can be applied on the back elastomeric element 30 by the pre-tension cable system 210). When lifting the object, potential energy is released by the myofascial tension line 350 to assist the user's back and shoulders (and potentially to the user's knees and elbows). Forming of the elbow tension lines 355 by the complex routing of the arm/elbow elastomeric element 220 assist user at the elbow level when lifting the object. Simultaneously, the knee actuation system 140 stores potential energy when the user 101 bends the knees, and knee actuation system 140 releases the energy when the user straightens the knees.

In FIG. 22D, the user 101 returns to the upright position (the upward squat is illustrated with arrow 2209) and uses the assistance provided by the myofascial tension line 350 and elbow tension line 355, as well as the potential energy stored in the myofascial tension line 350 to lift and carry the object. Back and shoulders are also supported by residual tension in the myofascial tension line 350.

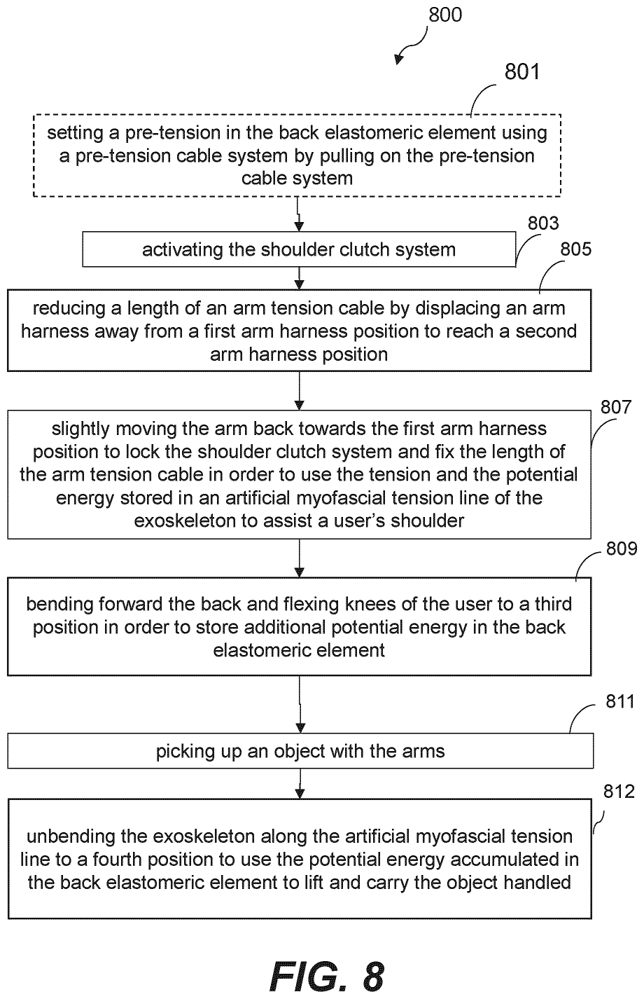

Referring to FIG. 8 and FIGS. 22A-22F, a method 800 for handing an object when wearing the exoskeleton 100 as described herein comprises: optionally, at step 801, adding (setting) pre-tension in the back elastomeric element by pulling on the pre-tension system and, at step 803, activating the shoulder clutch system 90 (turned ON). At step 805, a length of the arm tension cable 51 is reduced (in other words, the cable is reeled into the shoulder clutch structure) by displacing the arm harness 120 away from a first arm harness position (hands down in FIG. 22B) to reach a second arm harness position (hands up in FIG. 22B).

At step 807, the arm (and the arm harness 120) is slightly moved in the opposite direction to the previous arm movement, to lock the clutch and fix the length of the arm tension cable in order to use the tension and potential energy stored in the artificial myofascial tension line of the exoskeleton 100 to assist the user's shoulder. Such locking of the clutch may be achieved, with reference to FIG. 22B, by moving the arm slightly down after it has reached the upper position. For example, such slight move may be achieved when an angle between the arm and the user's body changes, for example, by between 5 and 10 degrees, between 5 and 30 degrees. At step 809, the back of the user is bent forward and the knees of user are flexed to a third position in order to store additional potential energy in the back elastomeric element 30. At step 811, an object 102 is picked up with the arms (as illustrated in FIG. 22C). At step 812, the exoskeleton 100 is unbent along the artificial myofascial tension line to a fourth position (for example, close to a standing position) to use the potential energy accumulated in the back elastomeric element to lift and carry the object handled (as illustrated in FIG. 22D). In some embodiments, prior to activating the shoulder clutch system and reducing the length of the arm tension cable and storing the potential energy in the artificial myofascial tension line, a pre-tension may be set in the back elastomeric element 30 using the pre-tension cable system by pulling on the pre-tension cable system.

In at least one embodiment, when the user 101 transports the object 102 using the back elastomeric element 30 as described herein, the back elastomeric element 30 of the exoskeleton 100 supports a portion of the weight of the object.

In at least one embodiment, prior to reducing the length of the arm tension cable 51 and storing the potential energy in the myofascial tension line 350, the shoulder clutch must be activated, otherwise the tension cable is free to be reel in and out of the shoulder clutch. FIG. 22A illustrates how to activate the clutch. Arrow 2201 illustrates a downward movement of the user's right forearm. Arrow 2203 illustrates a downward movement of the user's left arm.

In FIG. 22E, the user uses the assistance provided by the myofascial tension line 350 and elbow tension line 355 to support the object when dropping the object 102. Arrow 2211 illustrates the downward squat of the user.

In FIG. 22F, the user disengages the shoulder clutch system 90 manually. To disengage the shoulder clutch system 90 manually, the user uses his/her opposite arms to push a button on the shoulder clutch of the other arm. When the shoulder clutch 90 is disengaged, the user's arm is free to move again. The user thus can again adjust the length of the arm tension cable 51 without restriction to movement. Arrow 2213 illustrates a downward movement of the right arm of the user. Arrow 2215 illustrates a downward movement of the left forearm. It should be understood that FIGS. 22A-22F provide non-limiting examples of various positions, such as bent and unbent positions and positions of the arm harnesses and of the exoskeleton 100 as well as positions of the user's arms and of the user's body to illustrate operation and method of user of the exoskeleton 100.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

The invention claimed is:

1. A wearable exoskeleton for a body of a user, the body of the user having a front side and a back side, a median plane and a back functional line located on the back side, the exoskeleton comprising:
a front harness configured for positioning on the front side of the body and a back structural plate configured for positioning on the back side of the body, two shoulder bridges connecting the front harness and the back structural plate over shoulders of the body;
a back elastomeric element having two back elastomeric element branches, each back elastomeric element branch being coupled to a thigh harness positioned on a thigh of the user, the back elastomeric element being positioned to follow the back functional line of the body, to form an artificial myofascial tension line in the exoskeleton and to accumulate a potential energy when the back elastomeric element is elastically elongated, the back elastomeric element being configured to elongate either when the body of the user bends forward and/or flexes user's knees or when the user pulls on the elastomeric element with user's arms, such that the exoskeleton transmits the accumulated potential energy to the user either when the user returns to a standing position thereby providing an additional force to the user to unbend or when lifting an object with the arm thereby providing the additional force to support and lift the object; and
a pre-tension cable system coupled to the back structural plate and the back elastomeric element for setting an initial tension of the back elastomeric element.

2. The exoskeleton according to claim 1, wherein the pre-tension back cable system is coupled to:
the front harness of the user,
at least one cable guide attached to the back structural plate, and
a connector attached to the back elastomeric element, the pre-tension back cable system being configured to adjust the initial tension in the back elastomeric element.

3. The exoskeleton according to claim 1, wherein the back elastomeric element comprises two back elastomeric branches and forming a portion of the artificial myofascial tension line, each back elastomeric branch coupled to one thigh harness to be positioned on one thigh of the user, each one back elastomeric branch configured to be positioned over gluteal muscles and at least in part over lumbar region following the back functional line of the user.

4. The exoskeleton according to claim 1, further comprising tension cables coupled to an arm harness, optionally via a shoulder clutch system, and to the back structural plate.

5. The exoskeleton according to claim 1, wherein the shoulder bridges are structural elements, each shoulder bridge elevated above the user's shoulder and configured to reroute the tension cables towards an arm harness.

6. The exoskeleton according to claim 5, wherein the tension cables are rerouted towards the arm harness via a shoulder clutch system.

7. The exoskeleton according to claim 1, wherein each one of the shoulder bridges has an elevated upper shoulder bridge surface and a shoulder-engaging surface, a longest distance between the elevated upper shoulder bridge surface and the shoulder-engaging surface being about 5 centimeters.

8. The exoskeleton according to claim 1, further comprising an inter-arm elastomeric element, the inter-arm elastomeric element running from one arm and forearm harnesses to another arm and forearm harnesses through the back of the user and forming an arm tension line to assist user's elbow joints.

9. The exoskeleton according to claim 8, further comprising an elbow elastomeric element coupled to the arm and the forearm harnesses, the elbow elastomeric element having a plurality of pivot points, the plurality of pivot points defining routing of an elbow tension line located on the user's arm and a user's forearm, such that when moving the elbow of the user, a second potential energy is stored in the elbow tension line for using this second potential energy for moving objects with the user's arm.

10. The exoskeleton according to claim 9, further comprising a forearm harness coupled to the arm harness, the forearm harness being configured to receive and to adhere to a portion of the user's forearm, and the forearm harness being connected to the elbow elastomeric element and to the arm harness.

11. The exoskeleton according to claim 1, further comprising a shoulder clutch system, connected to an arm harness and an arm structure, an arm tension cable connected to the shoulder clutch system and configured to be reeled inside the clutch structure, such that when the clutch system is activated, the clutch system is configured to block the arm tension cable winding, and, in turn, to fix a length of the arm tension cable, and when engaged, the shoulder clutch system allows the user, by moving downward the user's arms to pull on the back elastomeric element to get support at the shoulder level and also to use the potential energy stored in the elastomeric element to lift and handle the object.

12. The exoskeleton according to claim 11, wherein the arm tension cable is slidably coupled to the back structural plate via a plurality of tension cables, each tension cable being slidably coupled to the back structural plate and slidably coupled to one of the shoulder bridges.

13. The exoskeleton according to claim 12, wherein each tension cable of the plurality of tension cables is coupled to the back structural plate via cable guides, the cable guides being immovably attached to the back structural plate.

14. The exoskeleton according to claim 1, further comprising a calf harness for receiving and adhering to a portion of a user's calf, the calf harness being coupled to the thigh harness.

15. The exoskeleton according to claim 14, further comprising a knee actuation system coupled to the thigh harness and the calf harness, the knee actuation system comprising a spring mechanism coupled to a knee cable configured to compress or expand the spring mechanism.

16. Use of the exoskeleton according to claim 1 to displace the object.

17. A method for handing the object when wearing the exoskeleton according to claim 11, the method comprising:
activating the shoulder clutch system;
reducing a length of the arm tension cable by displacing the arm harness away from a first arm harness position to reach a second arm harness position;
slightly moving the arm back towards the first arm harness position to lock the shoulder clutch system and fix the length of the arm tension cable in order to use the tension and the potential energy stored in the artificial myofascial tension line of the exoskeleton to assist a user's shoulder;
bending forward the back and flexing knees of the user to a third position in order to store additional potential energy in the back elastomeric element;
picking up the object with the arms; and
unbending the exoskeleton along the artificial myofascial tension line to a fourth position to use the potential energy accumulated in the back elastomeric element to lift and carry the object handled.

18. The method of claim 17 further comprising, prior to activating the shoulder clutch system and reducing the length of the arm tension cable and storing the potential energy in the artificial myofascial tension line, setting a pre-tension in the back elastomeric element using the pre-tension cable system by pulling on the pre-tension cable system.

19. A wearable exoskeleton comprising:
two shoulder bridges connecting a front harness and a back structural plate over shoulders of a user's body;
a back elastomeric element positioned to follow a back functional line of the user's body;
tension cables coupled to at least one arm harness, to the back structural plate, and to the back elastomeric element;
a shoulder clutch system connected to the at least one arm harness and an arm structure where an arm tension cable can be reeled; and
a pre-tension cable system.

20. The exoskeleton according to claim 19, further comprising an inter-arm elastomeric element, the inter-arm elastomeric element running from one arm and forearm harnesses to another arm and forearm harnesses through the back of the user and forming an arm tension line for assisting user's elbows.
